(19) United States
(12) Patent Application Publication
(10) Pub. No.: US 2005/0264474 A1
(43) Pub. Date: Dec. 1, 2005

(54) System and method of driving an array of optical elements

(76) Inventor: Rodger H. Rast, Gold River, CA (US)

Correspondence Address: RODGER H. RAST, 11230 GOLD EXPRESS DRIVE, SUIT 310 MS 337, GOLD RIVER, CA, 95670, US

(21) Appl. No.: 11/197,939

(22) Filed: Aug. 6, 2005

Related U.S. Application Data
(63) Continuation-in-part of application No. 09/924,973, filed on Aug. 7, 2001.
(60) Provisional application No. 60/223,659, filed on Aug. 7, 2000.

(51) Int. Cl. G09G 3/20

(52) U.S. Cl. 345/55

(57) ABSTRACT

A system and/or method for controlling a display array without the use of row and column drivers. The display elements within the system are configured to maintain an active address signal in response to a received signal containing serially encoded display settings. Each display element is loaded with an address of where it is located within the array. The display elements then extract the display information from the signal upon matching the address, wherein they output the correct display setting for their position within the array. An optical programming method is described for setting the address of the display elements in-situ.

### CROSS-REFERENCE TO RELATED APPLICATIONS

This application is a continuation-in-part of copending regular application Ser. No. 09/924,973 filed on Aug. 7, 2001; which claims priority from
provisional patent application Ser. No. 60/223,659 filed Aug. 7, 2000;
provisional patent application Ser. No. 60/559,441 filed Aug. 6, 2004;
the application also claims priority to copending regular patent application Ser. No. 10/612,221 filed Jul. 1, 2003; and
provisional patent application Ser. No. 60/394,160 filed Jul. 1, 2002;
the application also claims priority to copending regular patent application Ser. No. 10/670,432 filed Sep. 23, 2003; and
provisional patent application Ser. No. 60/413,199 filed Sep. 23, 2002; each of the foregoing application are incorporated herein by reference and priority to which is claimed.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to displays comprising an array of display elements and more particularly to a method and system wherein array address information is encoded within each display element wherein the elements may be controlled utilizing simplified driver circuits.

2. Description of the Background Art

Display arrays utilize a collection of elements which are controlled in concert with one another for displaying text or graphics. A scrolling LED advertising panel is typical of such a display array. These displays are increasingly utilized both outdoor and indoor for conveying information and advertising. The display elements within these arrays are typically LEDs which are usually provided as single color, dual color, or multicolor, such as red/green/blue (RGB). Large displays may encompass tens of thousands of elements for a large area display or marquee. The use of incandescent bulbs in signs is also prevalent within certain forms of signage, however, as the cost of LEDS decreases and the available intensity increases, fewer signs are utilizing incandescent. Although display arrays have become increasingly important, their basic designs [[have]] has not significantly changed since the 1970s.

In order to appreciate the beneficial aspects of the present invention, it is necessary to generally understand the design and construction of display arrays as they are currently being designed and produced. Elements of a display array are generally arranged in rectangular arrays with rows and columns. In systems with only a few discrete display elements, each element may be individually turned on and off by a controller in a direct (non-multiplexed) operation. However, display multiplexing, as generally shown in FIG. 1, was introduced to overcome the difficulty with providing individual signals for each element of a large array. Basically, in a multiplexed display each display element is connected across a row and a column, such that any element may be enabled, or lit up, by providing power on a column while pulling one of the rows to ground. By quickly scanning across the rows and columns each element can be individually driven for a small duty cycle. Multiplexing reduces the number of control lines necessary but results in a commensurate loss of maximum output intensity. It will be appreciated that each display element may only be driven for a small percentage of the time, depending on the depth of multiplexing utilized, and the achievable display intensity is therefore reduced. In the array of FIG. 1 it will be appreciated that power to one column may be applied wherein current sinking by the row driver activates any LEDs in that column, wherein each LED can be activated for a maximum of ⅙ of the total time as there are a total of six columns which are being driven. In displays requiring greater intensity, such as outdoor displays, the depth of multiplexing must be reduced and many displays utilize drivers for each display element.

A typical multiplexed small to medium sized display array comprises a housing, a backplane, driver chips distributed on the backplane, one or more controller chips for orchestrating the driver chips, a main processor, a power supply, and of course the display elements themselves. Considering a small two line display of 16 rows and 250 columns it will be appreciated that traces must be routed on the backplane to each element within the 16 rows and 250 columns. If multi-color elements are being used, then the two or three sets of rows and columns may be required for each element. On an array of even this miniature size, it would not be possible to multiplex the whole display with only one LED on at a time as each LED could be active a maximum of 1/4000th of the time. Therefore, separate drivers are typically provided for each column and the 16 vertical rows would then be multiplexed so that the elements can be active up to 1/16th of the overall time which would define maximum element brightness. Signal traces and drivers are required for each of the 250 columns and the 16 rows, and that the controller software must accommodate the structure of the multiplexing which is different for each display. Larger displays are generally composed of panels which act as separate displays that each have a controller and a set of row and columns. Each of these separate panels is integrated to one another by another level of driver circuitry. Very large displays can appear reminiscent of an antiquated mainframe computer, replete with complex racks of driver cards, and they are extremely expensive to produce and maintain. When faulty driver circuits occur, entire rows or columns of the display are affected and a service person is often required to locate a suitable replacement (often difficult as the driver circuits change so often) and then remove the surface mounted integrated circuits, with perhaps 100-200 leads, from the display array and solder in the new device.

Manufacture of display arrays is also complex and expensive. In order to fabricate a multiplexed display of a different/custom size a completely new design is required to suit the characteristics of the display. The design requires not only the design of a new backplane, but of all the drive electronics, as the row and column drivers are integrated for the specific number of rows and columns, and to one another, and also for the particular type and configuration of display element being driven. Often each display type and size utilizes its own proprietary control software to properly control the custom array of driver circuits whose operation is to be coordinated. For example, even a small change such as changing from 16 to 18 rows in the previous example would require a complete redesign of the display which would obviously be extremely expensive. Furthermore, it will be understood that large backplanes are expensive to fabricate and populate with distributed driver chips. Therefore, the costs are high even for a production run of displays, such as the 16×250 element array.

It is apparent that the display arrays pose numerous unresolved design problems with regard to multiplexed brightness, production cost, engineering cost, the capability to customize, the reliability, and the serviceability. Therefore, a need exists for a method and apparatus which would provide for controlling large arrays of display elements without the present “row and column” complexities and limitations.

The universal scanning method and system for driving optical elements in accordance with the present invention satisfies that need, as well as others, and overcomes deficiencies in previously known display array drive techniques.

### BRIEF SUMMARY OF THE INVENTION

The present invention is a method and system for driving and controlling arrays of display elements. The display elements used within the method can incorporate any conventional type of light modulation element (light generative, or reflective), such as LED, incandescent, laser, LCD, electronic paper, electromechanical, etc. By way of example and not of limitation, the display elements of the present invention will hereafter be referred to as universal scanning display elements, and will be considered to produce one or more LED outputs, referred to as a universal scanning LED, or USLED. Each USLED element appears similar to a conventional LED, yet contains on-board drivers and control circuitry. Incorporation of onboard drivers within an element has been possible for decades, yet doing so would not provide any benefits with display elements, such as LEDs, as the element would still require row and column multiplexing. The USLEDs have their own driver circuitry, and all elements, even elements which output three color RGB, are preferably fabricated as two pin devices. A prime advantage of USLEDs is that they may be arranged into arrays without the need of row and column drivers, and furthermore they do not require a complex backplane containing separate row and column lines. The display elements of the present invention may be easily formed into arrays of any form factor, shape, or curvature without additional complexity. Yet even without row and column signal lines, the display elements are individually controlled.

The USLEDs of the present invention incorporate what is being referred to herein as Array Position Addressing (APA) which allows the elements to be controllable addressed without the need of individual row and column lines. One aspect of APA on USLEDs involves a technique of in-situ optical programming wherein the USLEDs are programmed from an optical source array (generally a matching, or a superset, of the target USLED array) which programs a position address into each USLED on the target array. After programming, each display element retains, such as in FLASH memory, the address within the array that it is to be responsive to. A display array which is implemented according to the present invention contains a collection of programmable display elements, such as USLEDs, which are attached to a surface or backplane containing a power plane and a ground plane. During operation of the display, a drive voltage is applied between the power and ground plane that contains a superimposed serial APA control signal. The APA control signal comprises cycles within which, one or more data bits are contained for each element. A simple On/Off element requires only a single bit of intensity data while an RGB element may utilize twenty-four or more bits for color and intensity selection. Each display element monitors the serial signal pattern on the backplane and it receives its operating instructions at the address within the signal. Thereafter, such as at the end of a signal cycle wherein every display element has received a command, the display elements commence to display the desired state, by utilizing power from the backplane and modulating their own intensity/color based on the information received in the serial signal on the backplane. It will be appreciated that a display may contain display elements which are connected to receive different serial signals, so that the update rate of the display may be increased or to match certain signal receipt characteristics. For example, a large color display may incorporate different colors of elements, such as Red, Green, Blue, which may each be connected to a different power and signal plane within the backplane so that the update rate of the entire display can be tripled. It will be appreciated that the display elements may be divided in different ways from separate signals without departing from the teachings of the present invention.

Each display element, such as a USLED, preferably contains power conversion circuits to decode digital signals from the APA signal which are superimposed on the supplied power voltage. It will be appreciated, however, that one or more signal planes may be utilized that are separate from the power planes, although the complexity of the backplane may be significantly increased. The signals from the backplane are preferably decoded into an intensity (bit) clock, a column clock, a row clock, and a cycle reset. Alternatively, the addressing may use an absolute address instead of the row and column format and may incorporate the intensity clock within the absolute address. Additional addressing clocks may be added, if desired, to support three or more dimensions of addressing. Within this embodiment, the DC component of the applied drive voltage may be at either a normal operating voltage level, such as 6 volts, or at a programming voltage level, such as 12 volts; the voltages being preferably available separately within the circuit. From the applied power with superimposed signal, each USLED thereby extracts clocking signals to drive one or more internal counters. When the value of the counter matches a stored USLED address, the USLED then clocks in a predetermined number of bits framed on the intensity bit clock from the APA control signal. Preferably, the bits are stored until the end of the APA control signal cycle at which time they are latched as output to the display elements, such as LEDs in the case of the exemplified USLEDs. It will be appreciated that the relationship between the counter value and a stored address value need not be one of matching; only that there be a unique relationship such that each USLED may be individually addressed (e.g. could use subtractive, complements, and so forth). The technique is well suited to providing redundant displays of information, such as two sides of a display panel, with the same APA control signal, so as to reduce the necessary electronics within redundant displays. The USLEDs of the redundant portions of the display are simply programmed to the same address.

For display elements which are driven at various intensity levels, the multiple bits of latched output are employed to control a digital or analog intensity control for the output element. An intensity control may be implemented utilizing a number of methods, such as a weighted MOS FET ladder (simple current mode D/A converter), or a counter loaded from the intensity value such that duration of activation of the LED is determined by the loaded intensity value. It will be appreciated that “gray-scales” of any element may be produced by using the simpler On/Off control of each element while and toggling between on and off states so as to achieve a desired level of brightness; however, this method is less preferred as it incurs a burden on the control software.

It is anticipated that the universal display elements according to the present invention may be produced in a variety of shapes, sizes, and colors, with both monochrome and various multicolored elements being produced. The design of the display elements can allow these units to be mixed within a single display array. For example on a large advertising display a square region of tri-color (RGB) elements can be located within a field of grayscale single or dual color elements. The APA control signal electronics lend themselves to this form of mix and match, wherein each type of element is capable of extracting from the APA signal the proper drive signal for its own display type.

Although the addition of a circuit to each LED, or LED cluster, to create a USLED will initially raise the cost of the individual LEDs, however it is anticipated that once the production methods get well established and the quantity ramps up that the added cost per element will not be significant. The universality of the USLED and the elimination of the costly drivers, and backplanes, along with the reduction of troubleshooting expense will create overall reductions in the cost of the produced display arrays.

The preferred method of programming the addressing for the USLEDs is with an aspect of the present invention referred to as in-situ optical programming. A photodetector within each USLED is capable of detecting the presence of light. This photodetector preferably utilizes the PN junction of a/the display LED in either forward or reverse mode. An array of unprogrammed USLEDs are first attached between power and ground which is connected to an APA controller. The APA controller is also electrically connected, preferably through a voltage drop, to a preprogrammed array of USLEDs which is called a programming array. The programming array utilizes a set of programming USLEDs which are adapted USLED circuits for use in programming. A programming mode for the controller is selected wherein the controller outputs a signal corresponding to a slow-scanned moving active cell, wherein a single moving LED on the programming array traverses a fixed pattern, such as down each row in turn. The programming array is optically coupled to the unprogrammed array, such that light from each USLED of the programming array can be coupled to only one USLED of the unprogrammed array. It will be appreciated that should the arrays be optically-coupled face to face, then the preprogrammed USLED array should be programmed as a mirror-image of the addressing for the array being programmed. The unprogrammed array is receiving power with the APA control signals, but no LEDs are being lit as the address is not yet programmed and therefore no count matches occur. In programming mode, the APA controller is set to generate the APA control signal superimposed on a programming voltage, however, the preprogrammed display by virtue of the voltage drop, or other adaptation, remains in normal display mode and is not reprogrammed. With the programming voltage present, the USLEDs continue counting the APA control signal with the count being reset each cycle of the APA control signal. When a sufficient light level impinges on a USLED which is in programming mode, then the counter value is programmed as an address into a non-volatile memory within the USLED. The non-volatile memory may be in the form of FLASH cells, OTP cells, or alternative non-volatile storage. It will be readily understood, therefore, that each USLED is being programmed to match up with the operation of the programming array. Furthermore, once the new display array is programmed it may be given a test pattern, wherein the optically coupled programming array is utilized as a light detection array to register that each display element within the new display array has been properly programmed and operates correctly.

To replace a faulty USLED within a programmed array, a technician can easily program a new USLED for the proper row and column. A portable battery operated programmer can be produced from an APA controller, a single programming USLED circuit, and a row and column selection device. The unprogrammed USLED is connected, the proper address is set and the program button is pressed. The USLED is ready to be inserted into the array. Alternately, preprogrammed USLED could be obtained wherein the service person specifies the address desired. It will be recognized by those in the industry that the inventive system described should exhibit increased reliability over current display arrays, and that it should be possible for untrained personnel to repair the displays due to the elimination of the complexity of row and column diagnostics.

Another of the methods of USLED programming according to the invention requires the use of a one-time programmable non-volatile memory which does not require an extended programming voltage, but only a load pulse. Within this arrangement the programming voltage is eliminated but an extra bit of the non-volatile memory is added to contain the program state of the USLED. A new USLED thus starts with this bit set to a state of “unprogrammed”. When power is applied, the USLED in the unprogrammed state does not output any light but senses light from the photodetector (preferably one of the same LEDs used to generated light output), and the non-volatile memory (NVM) is loaded in response to a light input. When the NVM is loaded, the state of the program state bit is toggled to “programmed”. When in programmed mode the USLED is only capable of generating light and can not be further programmed.

It must be appreciated that variations of the invention can be implemented without departing from the methods of the present invention. Specifically, the USLEDs may be programmed without use of the aforesaid in-situ optical programming technique. As an alternative the USLEDs may be programmed to fixed addresses prior to insertion into the array, or configured with a programming pin through which in-situ programming may be performed. However, the simplicity of replacing a faulty USLED in the field will be lost in many of these variations.

Preferably, the circuitry according to the present invention is incorporated within the display element itself so that a single universal scanning element is created. The techniques and described circuitry can be used with any form of display element such as LEDs, laser diodes, infrared diodes, incandescent lights and so forth. The circuitry may be incorporated within the die of a display LED, or it may be provided as an integrated circuit die to which one or more display elements is bonded such as by a “Flip-Chip” method, or another such means. The circuitry of the present invention would thereby become a carrier for the display element (one or more LEDs) which would then be encased within the optical housing which may appear as a typical LED. Alternatively the chip could be bonded to a substrate to which one or more elements is connected, such as three separately housed RGB elements or an incandescent light. In considering the use of modules having three separate elements connected to individual display elements: it will be understood that since the elements are not constrained to conventional row/column addressing, RGB elements may be placed in proximity within the array and addressed non-consecutively such that each may be addressed as a color plane (i.e. reds addressed as 000h,000h to 01Fh,0FFh; greens addressed from 020h,000h to 03Fh,0FFh; and blues addressed from 040h,000h to 05Fh, 0FFh). Configuring the addresses in this manner simplifies the task of the display system software to convert an image for proper display and may eliminate the impetus for using modules containing multiple elements. It should also be appreciated that LEDs may now be fabricated on substantially conventional silicon dies, wherein the display element and the drive circuits share the same single die. Therefore, it will be recognized that the cost of integrating control electronics within the display element is being increasing driven downwardly by technological advances.

An integrated circuit form of the described circuitry would preferably contain configuration options and test connections. For example, the universal scanning circuit may be bonded to LEDs as display elements or as a programming LED. In addition access should be provided to critical circuit areas for chip testing.

Display arrays may be created utilizing the system and method of the present invention to simplify the drive electronics and the complexity of the backplanes and interconnections that are conventionally required. A sample of the displays that can benefit from the present invention include: small and large outdoor advertising displays, indoor signage, Christmas-light style light strings (single axis array), Christmas-light style lights with hanging “icicles” (as one or two axis array), displays on electronic equipment (i.e. display of a treadmill, a network analyzer, and so forth), fau-neon lighting (single axis array encapsulated to appear similar to a neon sign), automotive lighting (such as tail lights, brake lights and so forth), and in any application wherein a series of display elements need to be driven by a controller.

In one embodiment of the invention a system and method are described for correcting intensity and color for USLEDs, wherein correction factors are stored in the USLED based on registered output from the LEDs to correct intensity and color factors.

An object of the invention is to provide for the production of display arrays that do not require a complex backplane with conductive pathways or drivers for the rows and columns of display elements.

Another object of the invention is to provide a simplified method of driving display arrays that may comprise single or multiple axis arrays of elements.

Another object of the invention is to provide a simplified method of driving display arrays that may comprise elements configured to display one or more intensities and/or colors.

Another object of the invention is to provide a simplified method of driving arrays of display arrays for animated displays.

Another object of the invention is to reduce the production cost of production quantity display arrays.

Another object of the invention is to reduce/eliminate the engineering cost involved with the creation of custom displays.

Another object of the invention is to allow the use of full intensity within the display elements so that brighter displays may be created and higher contrast ratios supported.

Another object of the invention is to provide a set of universal display elements from which displays of any configuration, shape, or form factor may be created.

Another object of the invention is to provide a standard display element which is fully scalable to any size, and is compatible with a variety of display element types within the same display.

Another object of the invention is to provide a display in which the operational relationship of the elements does not depend on a physical relationship, such as the row and column traces of a conventional display.

Another object of the invention is to provide a display array in which elements or areas within the array can be randomly accessed and loaded with new display settings while the remaining elements continue displaying information loaded from a prior cycle.

Another object of the invention is to provide a display array in which reliability and serviceability are greatly enhanced, due to the elimination of complex backplanes and driver circuitry.

Another object of the invention is to provide displays which can be controlled from a standard controller—with no need to create custom electronics and firmware for each unit.

Another object of the invention is to provide a mechanism whereby field repairs of a display unit may be carried out by an unskilled technician in a minimum of time.

Another object of the invention is to provide display elements according to the invention which have internal color and/or intensity correction.

Further objects and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a block diagram from a conventional multiplexed LED display array, showing six columns and seven rows of LEDs that may be drive.

FIG. 2 is a schematic of an embodiment of a USLED according to the present invention, showing a RGB USLED designed for in-situ optical programming.

FIG. 3 is a schematic of a counter according to one aspect of the present invention, which compares a count value with a programmed address.

FIG. 4 is a schematic of an embodiment of an RGB USLED according to the present invention, showing a programming qualification circuit.

FIG. 5 is a schematic of eight USLEDs and an APA ballast connected to an APA controller according to an embodiment of the present invention.

FIG. 6 is a schematic of a representative embodiment of an APA controller according to an aspect of the present invention.

FIG. 7 is a section of a base member capable of supporting an array of universal scanning elements according to the present invention.

FIG. 8 is a cross-section of the base member of FIG. 7, showing the holes for mounting a display element.

FIG. 9 is a cross-section of the base member of FIG. 8, adapted with inserted connectors for which a universal display element is positioned for insertion.

FIG. 10A-10B are flowcharts of programming and operation of the USLED, or similar display element, according to an embodiment of the present invention.

FIG. 11 is a schematic of a USLED which is configured within internal color and/or intensity correction according to an embodiment of the invention.

FIG. 12-13 are schematics of a device array substrate for use with the USLED techniques according to an aspect of the present invention.

FIG. 14 is a schematic of a display array utilizing USLED techniques for on a heat sinking substrate.

FIG. 15 is a schematic of a USLED based display having OLED within a panel according to an embodiment of the present invention.

FIG. 16 is a schematic of an embedded display control circuit according to an aspect of the present invention.

FIG. 17 is a flowchart of in-situ optical programming according to an aspect of the present invention.

FIG. 18 is a block diagram of a display element configured for receiving in-situ optical programming.

FIG. 19 is a flowchart for a method of setting location addressing with an automated assembly system, such as pick-n-place, according to another aspect of the present invention.

FIG. 20 is a flowchart for a method of peer programming according to an aspect of the present invention.

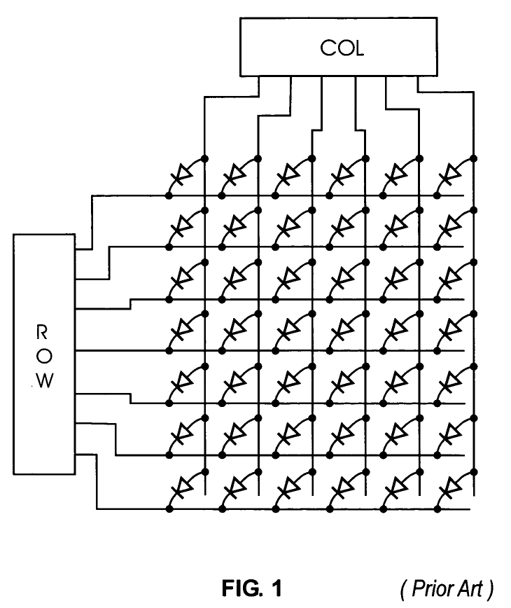

### DETAILED DESCRIPTION OF EMBODIMENT(S)

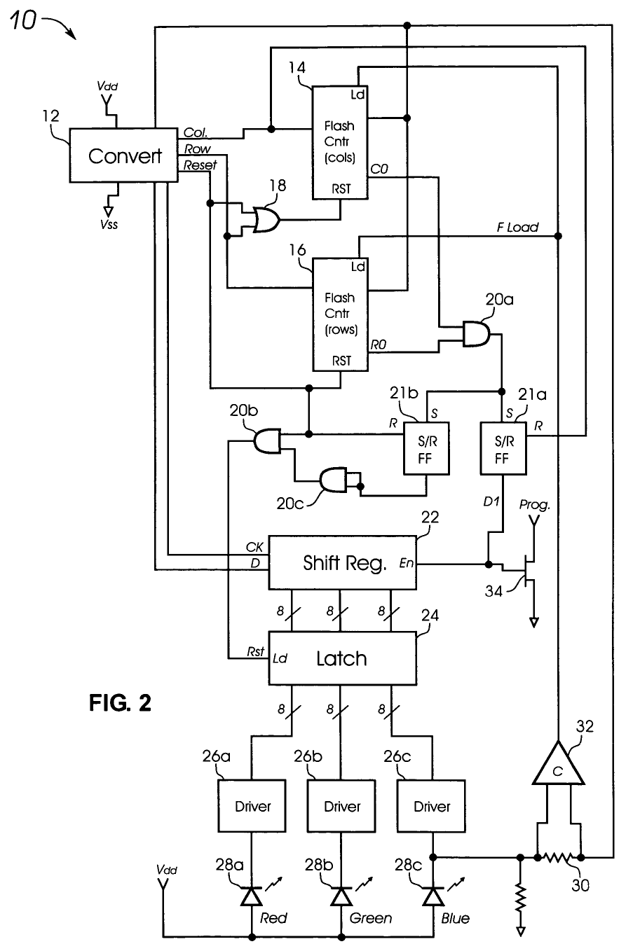

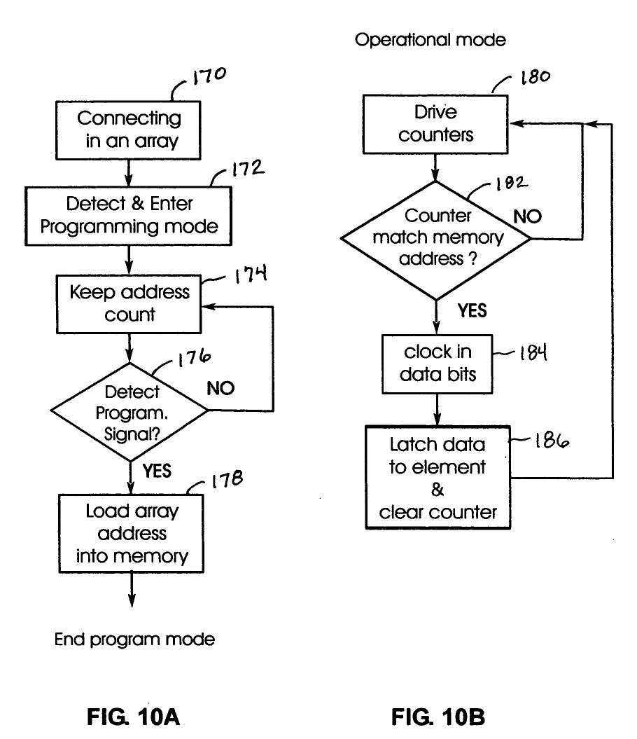

Referring more specifically to the drawings for illustrative purposes, the present invention is embodied in the method generally described in FIG. 2 to FIG. 20. The following description is presented to enable one of ordinary skill in the art to make and use the invention as provided in the context of a particular application and its requirements. Unnecessary technical details, which extend beyond the necessary information allowing a person of ordinary skill in the art to practice the invention, are preferably absent for the sake of clarity and brevity. Furthermore, it is to be understood that inventive aspects may be practiced in numerous alternative ways by one or ordinary skill without departing from the teachings of the invention. Therefore, various modifications to the preferred embodiments will be readily apparent to those skilled in the art, and the principles defined here may be applied to other embodiments. Thus the present invention is not intended to be limited to the embodiments shown, but is to be accorded the widest scope consistent with the principles and novel features disclosed herein.

Referring more specifically to the drawings, for illustrative purposes the present invention is embodied in the apparatus generally shown in FIG. 2 through FIG. 9. It will be appreciated that the apparatus may vary as to configuration and as to details of the parts without departing from the basic concepts as disclosed herein.

Circuit Embodiment of a USLED.

One embodiment 10 of a USLED is exemplified in FIG. 2, having been integrated with a red, green, and blue LED display element. The power received by the USLED contains superimposed control signals which are extracted by a conversion circuit 12. The embodiment shown utilizes four embedded signals, an intensity clock, a column clock, a row clock, and a reset signal. These signals are embedded on the power bus using any of numerous conventional data encoding techniques, which may utilize reversing bits, bits of differing amplitude or phase. This embodiment is shown configured requiring the use of a programming voltage when programming the non-volatile memory within the circuit.

Generally speaking, the clocks are used to drive circuit counters within the universal scanning element that define intervals for the intensity bits, the columns, and the rows of the display. The reset signal is generated at the end of each cycle (frame), after each active display element has been programmed, and it resets all the counters to an initial state and also triggers the change of state of the display to the newly loaded pattern. With each count of the column counter, the address shifts one column position in the array. A row clock is generated at the end of each row of elements, and it causes the row counter 16 to advance and the column count to be reset through OR-gate 18. It will be appreciated that the column counter could overflow to accomplish a similar function, however, using a row clock allows the USLED circuit to be designed to support a very large row length even if just a portion of that row is populated with display elements. An objective of the invention that should continually determine the preferable arrangement for the circuit is that of creating a substantially universal circuit which may be used within the display elements of any display array.

The counters 14, 16, contain non-volatile memory (NVM) cells that are programmed to an address for the specific USLED within the array of elements. As the count of columns and rows advances, it is continually compared with the address loaded in the memory cells. Upon a match being made of column and row the output of gate 20a sets the S/R flip-flops 21a, 21b, which enables the shift register 22 so that it begins clocking in data bits framed by the intensity bit clock. Upon arrival of the subsequent column clock, the shift register is disabled and statically retains the intensity bits for this USLED. This particular USLED has red, green, and blue elements each having 256 levels of brightness, so that twenty-four intensity bits are utilized, which are clocked into the shift register 22 from the intensity clock being extracted by the converter 12. It will be appreciated that the USLED circuit shown may be used to drive a single LED with up to 256 intensity levels as the relationship of the number of intensity clocks between column clocks determine how many bits are stored to define the intensity. For a single LED a total of eight intensity clocks would be preferably generated between each column clock. Display elements, single, double, or triple, may be mixed within the same array of elements when the APA generates clocking according to the deepest clocking necessary for any element.

The data in the shift register 22 is retained until all the USLEDs in the panel have been addressed at which time the APA controller generates a reset signal. The reset clears all the counters and triggers the loading of a latch 24 from the shift register 22. The output of latch 24 is set according to the updated data and signals are provided to drivers 26a, 26b, 26c, for each of the corresponding LEDs 28a, 28b, 28c. These drivers provide current mode D/A converters for the LED being driven, and may be implemented in various configurations according to present practices. It will be appreciated that the intensity of the LEDs may be equivalently driven by altering the amount of time they are activated within a particular display cycle, therein counters would be utilized instead of D/A converters.

Since the change in LED state may be accompanied by sizable overall current changes within the array, the reset signal is preferably generated twice in succession. After the first reset, the reset is sent again after a delay and to again clear the counters. The S/R flip-flop 21b provides qualification of the reset signal so that only the first reset signal clocks data into the latch. The prequalification prevents spurious data from being latched if noise from the transition were to trigger a row and column match and an intensity clock signal. This simple precaution adds additional security to prevent false display settings, as no display reading can be latched unless a valid address match occurs during the APA cycle. The prequalification also allows the use of random addressing wherein only the sections of the array which have changed need to be updated with new display data. In addition, faulty display elements are constrained to “showing up” as unlighted elements, rather than displaying “garbage” which could be difficult to discern from proper operation (garbage could follow an all elements ON or OFF diagnostic display). When the first reset arrives, the S/R flip-flop 21b should be in a set state if this USLED was addressed during the cycle, which should be true on each cycle. The output of flip-flop 21b is ANDed with the reset signal to drive the load input of the latch. The reset signal also resets flip-flop 21b to a reset state. The AND gate 20c provides an additional propagation delay to lengthen out the load pulse whose length is determined by the race condition of the signals to AND gate 20b.

Reset is generated by the APA controller on the power bus after all active elements have been loaded; however, as not all definable positions are generally populated, the reset will typically be generated as soon as all addressable elements have been programmed, so that a subsequent cycle may commence. The USLED circuit can therefore be implemented to accommodate very large display sizes but the same circuit may be used with small circuits without losing efficiency or compromising the update rate. It is expected that USLED circuits will be specified for operation within a given frequency range, as given by the clock rates, and designers can then configure the APA controller speed to suit the needs and size of the array, or vary the clocking rate within a specified range to accommodate the necessary update rates for the display.

Loading of all display elements has been described in the preceding section, however, it should be appreciated that a form of random addressing may be performed. If only one section of the display needs to be changed, then after the prior APA signal cycle is complete, the row count can be incremented, without the need of supplying column counts or intensity data, until the proper row is selected after which column counts may be given without data to arrive at the selected area to which data is then loaded. After loading the data to the selected area, the addressing may continue to another area, or the reset signal may be generated to get the addressing back to the origin. The elements which have not received new data will continue to display the data contained within the intensity data latch (reset pulse will not reload latch as no address match was made during the cycle). This form of random addressing allows a slower overall clock cycle, yet the display can be updated quickly for better animations.

It will be further realized that the APA controller can be configured for the capability to operate at various frequencies so as to reduce RF noise and circuit power consumption. Preferably, the signal extraction circuitry of the USLEDs will be capable of maintaining reliable signal extraction over a wide range of operating frequencies.

The receiving and displaying of data by the USLED has been described according to FIG. 2, wherein the addressing and data provided by the APA controller were used to set the state of the display(s). However, the mechanism utilized within the embodiment for setting the address of the particular USLED has not been described. The embodiment of FIG. 2 utilizes in-situ optical programming wherein the address of a particular USLED is determined by pulsing a light to the USLED when the desired address to which the USLED is to be programmed appears on the power bus. It will be recognized that PN junctions are sensitive to light in both forward and reverse directions, which makes the use of the output LED as an optodetector a logical, and inexpensive, choice. A simplified diagram of light detection is shown in FIG. 2. Current flows though resistor 30 through the back-biased diode when the program voltage is provided to the circuit. The amount of the reverse current flow depends on the amount of light impinging on diode 28c. The comparator 32 registers the current and its output is triggered when sufficient light is detected. The output of the comparator drives the load signal for programming the non-volatile memory of the counters to the current count value. An alternate LED driving FET 34 is shown which allows the universal scanning circuit to be used within an optical programmer, as it generates light output only while the element address is active.

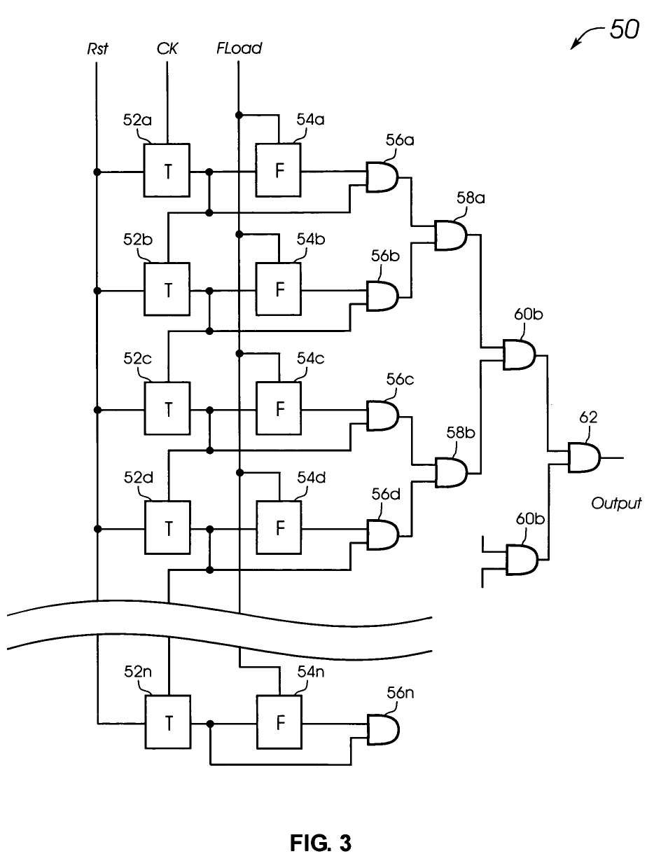

FIG. 3 is a diagram 50 of a representative counter containing non-volatile memory and a matching circuit. A series of toggle flip-flops 52a-52n are shown in cascade which receive a common reset signal. The output of this binary counter is received by non-volatile memory cells 54a-54n. The outputs of the memory cells are always active and are compared with the output of the counter via levels of gating represented by gates 56a-56n, 58a-58b, 60a-60b, and 62. Only a portion of the counter circuit is shown in FIG. 3 as it may span numerous levels. Upon receiving a load pulse (when the programming voltage is set to high—connection of programming voltage not shown), the data being output by the counter is loaded into the non-volatile memory which sets the address for the USLED. This allows address programming to be performed in-situ after the array of display elements have been assembled onto a power plane backing. Preferably optical programming is performed after assembly, wherein an array of programming USLEDs with a similar pattern (which has been programmed already) is optically coupled to the unprogrammed array by placing it over the display with cylindrical tubes from the programming array encircling the optical elements of the target array, so that maximum light is coupled to it. The programming USLEDs are configured to generate an intense light immediately upon address match, and the circuits may be produced using the same universal scanning circuit to which the LED had been alternately connected, as exemplified in FIG. 2 by FET 34. It is possible to use a single APA controller to generate the signals for both the unprogrammed and programmed display (with the programmed display having been programmed to the reverse image of the desired programming of the target display).

USLED without High V Programming.

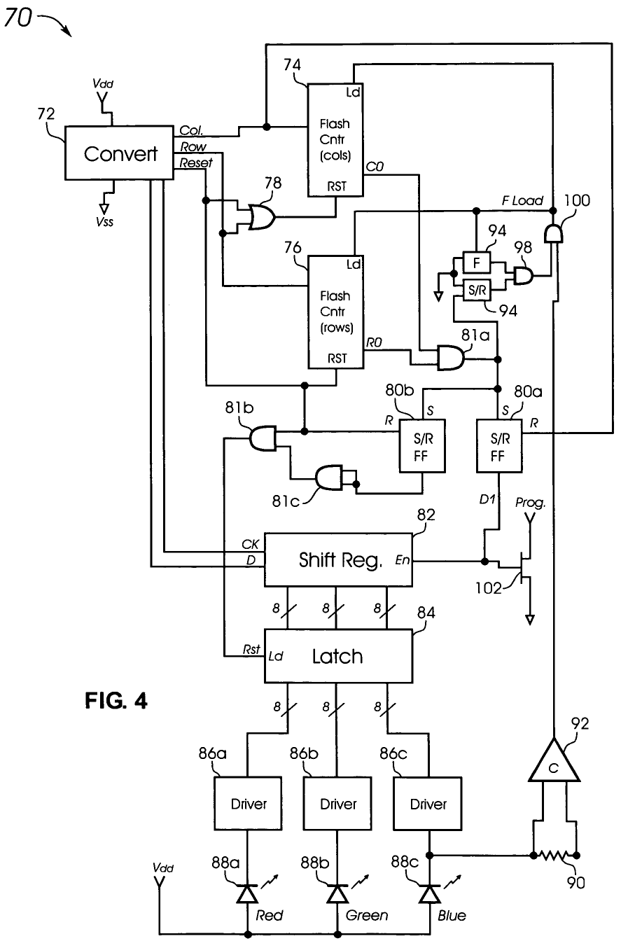

FIG. 4 contains another embodiment 70 of an RGB USLED whose non-volatile memory does not require a high voltage programming level to initiate programming of the device. To control the programming of the element, a non-volatile memory cell was added 94, which is initially in an unprogrammed “1” state. An S/R flip-flop 96 is connected so as to power up in a reset state. When the counters are unprogrammed their non-volatile is set to all ones which corresponds to the last address possible for the APA control signal (an address not populated by a display element). To prevent the USLED from getting accidentally programmed, a preprogramming step is provided wherein the cycle is APA cycle is extended up to the highest address wherein all unprogrammed USLEDs are selected (with data=0). This selection is performed once the system is ready for programming and established in optical connection with the programming display wherein no extraneous light can inadvertently trigger loading. The selection activates the set line of S/R flip-flop 96 to preselect the device for programming. At this point each USLED device will be programmed upon encountering a light pulse. As sufficient light is received, comparator 92 generates a program signal. Since the non-volatile memory is set to all “1s”, the cell 94 is outputting a 1 which indicates unprogrammed. Combined with the output of the S/R FF, the programming signal is gated through to load all the non-volatile memory (counters and the separate cells). Once programmed, cell 94 is set to “0” such that the USLED can not be reprogrammed.

Array of USLEDs coupled to a Controller.

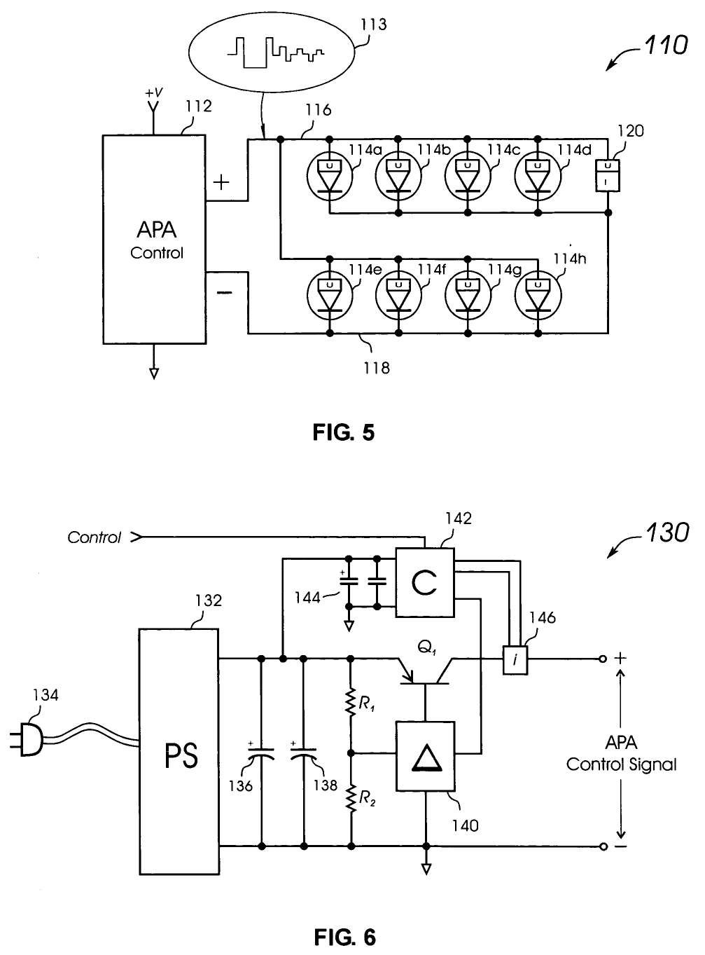

FIG. 5 shows an array of USLEDs connected to an APA controller, although the number of elements is very small for an array (eight) it represents the connections necessary to construct a display array according to the present invention. The USLED are schematically shown connected with a trace, however, it will be understood that in general use a planar region is preferred. An APA controller 112 is shown with a power connection and having a two-wire output. A signal 113 is shown encircled as representative of the APA signal which shows large square wave pulses for reset and pulses for the column and row clocking. A positive voltage connection 116 and a negative voltage connection 118 are made to each of the USLEDs 114a through 114h. It will be recognized that the symbol shape for a USLED provided herein is given by a diode symbol having an additional rectangular box which in this case contains a “u”. Additionally, an APA ballast element 120 is shown on the power bus. The ballast 120 is an optional element for use in large arrays which is capable of minimizing current fluctuations on the power bus and its optional use will be described later. It should be appreciated that the display array has but a two wire controller and a series of USLEDs connected between power and ground, there are no row or column traces, nor drivers, to contend with.

FIG. 6 is an APA controller 130 according to an aspect of the present invention. A conventional power supply 132 accepts power from a source, in this case a 110 VAC wall outlet 134. The output of the supply is well filtered by capacitors 136, 138. A modulator 140 is controlled by a microcontroller chip 142 that is executing instructions to control the display. The modulator 140 is capable of altering the conduction of pass element Q1 so as to impose a small signal on the output as the APA control signal. The microcontroller chip 142 is supplied from the power supply and fitted with bypass capacitors 144.

A current sensing element 146 is optionally provided for use in detecting faulty operation, such as a faulty element within a driven array—wherein the elements are driven as one per cycle and the current is measured. Elements whose current draw fall out of range are suspect and should be checked. To simplify the isolation of faulty USLEDs within a large array, this fault finding mode of the APA controller may be selected. Such current sensing is possible because unlike multiplexed displays, the entire array is capable of static operation, such that with a single display element active the clocking can be suspended, such that all circuits are only drawing a minimal (measured) quiescent current, and the current draw of a single display element can be detected as an increase corresponding the active display current. A single display element is selected and the APA stretches out the timing cycle during an address (the circuitry is then all static and drawing meager power) to allow a proper measurement of current level to be made. If the current level is outside of the normal range, then the controller can display the row and column of the suspected faulty LED as a row and column number, or by encircling the suspect LED with lighted elements and toggle the suspect LED on and off so the technician can check if it the display element is indeed faulty. If the element is faulty then the technician can replace it on the spot.

In large displays, a remote control for the display array is preferably used which provides RF communication between the technician at the display and the APA controller, as well as allowing new USLEDs to be programmed on the spot. The APA controller can even transmit the suspected address to the remote so that the technician need only plug an unprogrammed USLED into the controller and press the button and the new device is ready for insertion to replace the device being encircled on the display by the APA controller. This mode can continue until all faulty element have been reported. This testing mode may also be entered for few cycles (testing a few LEDs) during screen blanking intervals so that over a period of time all LEDs are being tested with a report being selectively generated on demand, or at intervals.

In considering the supply noise generated by the circuit elements it will be appreciated that all USLEDs within the array are in a static state during a cycle of APA control signal. The LEDs being driven are allowed to transition from one intensity level to another only after receiving the reset signal. The reset signal preferably comprises duplicate cycles, such that the first cycle resets the counters and commences the state transitions of the LEDs, or other display elements, while the delayed second transition occurs after the power bus has stabilized, and it again resets the counters in case any glitches caused by the transition. After the second reset signal, the current being drawn from the power bus is again stable at a fixed current level and thereby the APA signals riding on the power bus are unaffected. The power bus on which the USLEDs are mounted will be preferably implemented with a low impedance, which should be easily attainable as a power plane and a ground plane since no other signal traces need to be incorporated.

If the power supply itself is unable to stabilize in a short enough interval then measures can be taken to mitigate the current transition. One aspect of the invention allows for adding programmable ballast devices distributed on the power bus. These devices are similar in structure to a USLED element, but instead of having a display element they are configured with the driver as shown in FIG. 3 shorted to ground so that a programmable load may be added to the power bus. It will be appreciated that such a ballast load can employ the same control circuit as used within a USLED but preferably with a bondout change so that the driver can source a high current that is equivalent to the current of numerous USLEDs (50-200) and packaged differently to suit their dissipation and for allowing them to be mounted without disrupting the configuration of the display array. These ballast loads can be distributed on the power bus (they can be on the backside, or between array elements as they need not have same form factor) and will be programmed by the APA controller each cycle to maintain a balanced current draw from the power supply. The addresses for these APA ballasts are preferably set at a fixed set of addresses within a particular row, such as near the end of the last row, (just prior to the last address which is for preprogram selection) so as to allow common use within a variety of devices. With fixed addresses, the ballasts need not be programmed, only inserted on the bus and properly controlled by APA controller which can estimate the change of current and program the ballasts to maintain a substantially stable current draw.

The design of APA ballasts could become quite sophisticated, and another embodiment of APA ballasts could provide a load that acts as the above load, but with another driver that acts to snub the current change by drawing an initially high current, then tapering the current draw off slowly. It will be recognized that using a tapered current draw would lower the overall dissipation of the system and allow setting a current equilibrium point at a lower level to maintain balance. Regarding the foregoing description of APA ballasts; it must be understood that such devices should not typically be necessary, but are provided as optional components of the system which may be used in selected instances, such as for reducing the cost or complexity of the power supply system.

It should be appreciated that very large displays may be broken down into a series, or an array, of smaller displays, to support a larger number of elements than can be supported within a single array. Multiple APA controllers are therefore utilized in concert to control these separate areas of the display under the control of a master controller which sends the appropriate information out to each of the separate APA controllers.

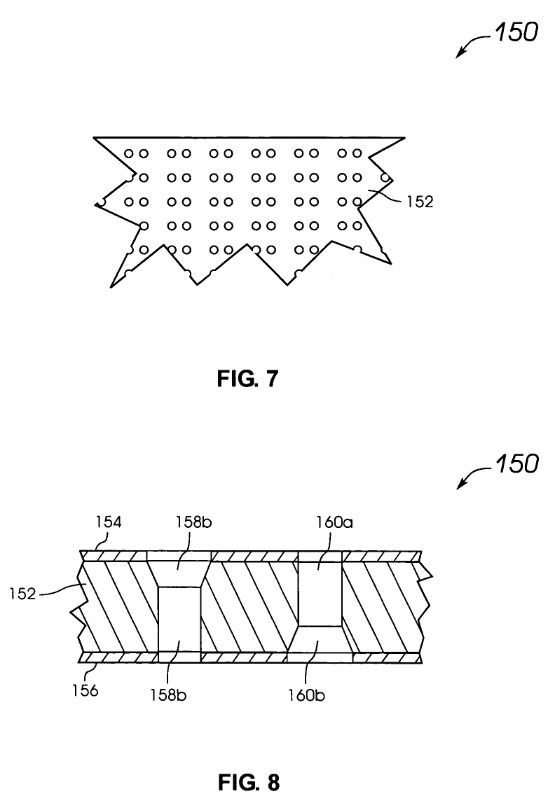

The method and system of the invention allow for new display array uses, production methods, and troubleshooting. Numerous methods of producing display arrays are anticipated by the present invention since the complex backplane replete with distributed drivers can be replaced with simple power and ground connections. These power and ground connections may be provided by a single pair of wires, such as to form a single-axis display array, or as interconnected wiring, traces, or backplanes to form one or two-axis arrays. Backplanes may be easily configured in the present invention through which sufficient current and signal may be supplied to the display elements. Sheets of non-conductive material, such as aerated plastic (light weight non-conductive material), can be formed with conductive opposing faces to carry the ground and power planes. A representative structure 150 is shown in FIG. 7 through FIG. 9.

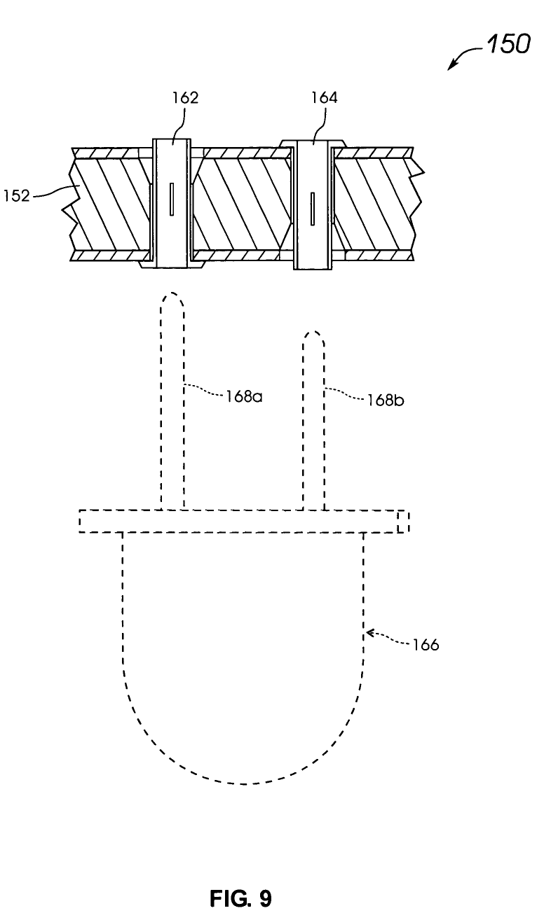

A base material 152 would preferably be thick but compliant and light with integrated connectors. The plastic base material 152 is shown metalized on both sides 154, 156, by conventional processes, such as sputtering, painting, or laminating. Holes 158a, 160a, with tapered relief's 158b, 160b, in FIG. 7, are cutout from opposing faces so as to allow the inserted connectors 162, 164, as shown in FIG. 9 to contact only one conductive face of the material. A USLED 166 with leads 168a, 168b, is shown in preparation for insertion within the connectors 162, 164. The leads of the USLED are shown as conventional square LED leads, however it will be recognized that the material can be configured with various forms of connectors, such as bayonet, screw-in, and similar. The material shown is preferably at least 1/8 inch thick to provide a large contact surface with the USLEDs (multiple wipers) and to properly support the USLEDs as perpendicular to the base material. It will be appreciated that such a structure can be cut to any desired shape, populated with USLEDs, connected with a APA controller, and programmed, so as to provide a display array suitable to the application. It will further be appreciated that the base material of the array may be curved or bent to suit the application. The base material may also be formed, or molded, into any desired shape to which the array of USLED will be attached.

USLED—Intensity and Color Correction Programming.

As it is often difficult to assure that all optical devices provide the same optical characteristics, such as intensity and color, for a given optical setting. This is particular applicable to output devices, but may also be utilized with devices which provide optical input as well as output or in lieu of optical output.

This aspect of the invention assures the consistency of elements being controlled by the USLED interface. In one embodiment the color and intensity of optical outputs are calibrated, such as a full color LED element, by storing calibration factors for the device within the USLED element, preferably at the time of position programming the elements, such as in-situ programming described previously.

It should be appreciated that all descriptions of outputting from a display element, may also be less preferably utilized with devices used for input, such as detector elements which can need correction as well as output devices.

Each of the USLED devices in a display, are triggered into generating an output, the characteristics of which are registered and from which correction factors are determined (i.e., calculated or looked-up in a table). The corrections are then programmed into the devices, such as in the same non-volatile memory (i.e. FLASH) utilized for storing the address of the element within the display array. The corrections for example can be stored into the USLED units at the time the addresses are programmed.

In one embodiment of the invention the USLED circuits previously described are modified to allow loading data into the NVRAM from the common signals received by all the USLEDs, in response to detecting the correct address. The circuit is already configured for detecting the presence of a programming trigger, such as a light, RF signal, inductive signal, and so forth. When the device is set to programming mode then in response to this programming trigger it loads the value from a counter into the NVRAM, which sets the address of the element in the array.

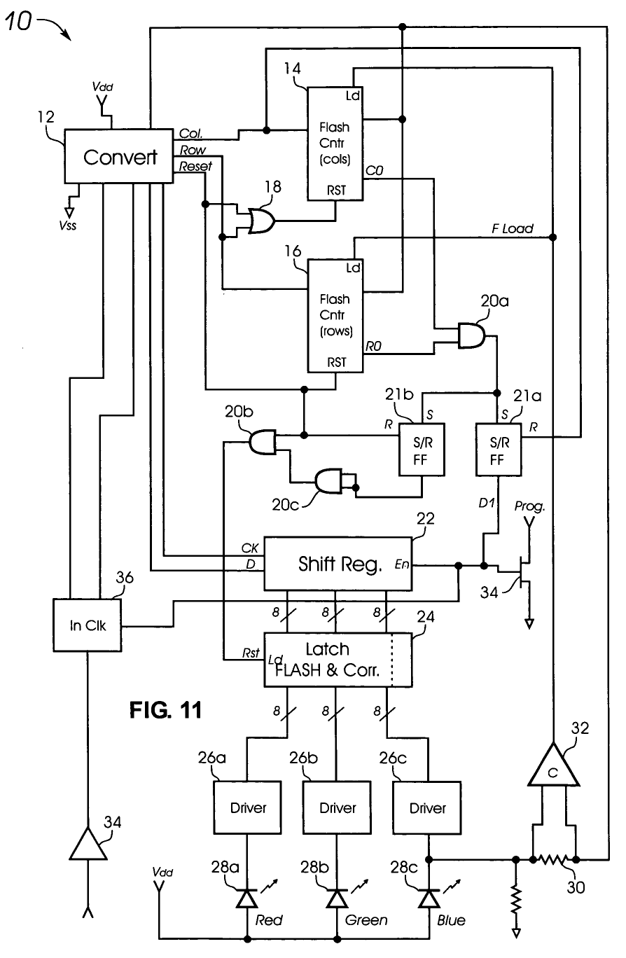

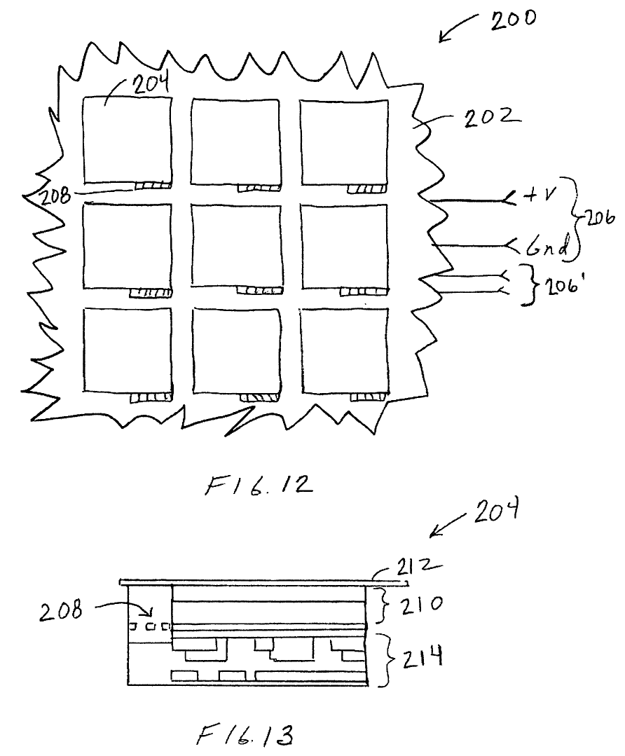

FIG. 11 is similar to the earlier USLED schematics, but contains color and/or intensity correction circuitry. The device of LATCH 24, which takes the data from the shift register for sending the signals to drivers 26a-26c for powering the LEDs 28a through 28c has been modified to a Latch with FLASH and correction circuitry 24′. After the device has received a programming signal, such as detected by the LED in detector mode as symbolized by LED 28C whose leakage is sensed by comparator 32 to generate a programming signal in response to receiving sufficient light when the USLED is in programming mode. At the time the address is loaded into the Flash counters 14, 16, circuit 24′ enters a programming mode. In this embodiment the flash counters 14, 16 are configured to generate a valid output as if the proper address had been reached (which technically it has, only in programming mode). Therefore the shift register operates conventionally to pull a desired number of bits of data from the common signal. Since latch 24′ is in a special mode the data is pulled from the signal and loaded into non-volatile memory, such as FLASH, as a correction factor for the LED drivers. The correction factor is applied to a correction circuit in latch 24′ whose output is received by drivers 26a-26c for controlling the output of LEDs 28a-28c.

It should be appreciated that the circuitry can be readily modified to allow any desired number of bits to be pulled from the common line to provide correction data. The correction circuit may provide correction of the duration of activation, voltage applied, current applied to the LEDs (i.e. linear or PWM), the ratio between LEDs to control color, and other aspects of circuit control. The correction factors are preferably stored in combination, although data for each LED (if more than one exist) can have its own correction factor storage. The correction factors are received based on the actual measured performance of the LED in the given circuit, wherein the correction is made very accurate. Preferably the intensity of the LEDs in each USLED are registered by a single detector that registers the output of each LED therein assuring that results are not skewed by having detectors of different performance.

For example, the correction factor may comprise control of active duration and current. The correction factor can then be utilized to map two variables into a single variable, such as called intensity, which takes into account both the signal duration and the current output. In this way the signals sent to the USLED can be simplified without the need to send huge pieces of data. The output from the LED has been linearized by the correction circuit in response to the correction factors received.

To increase the resolution of LED intensity settings more data can be pulled off the line, such as 12, 16, 24 or even 32 bits per LED. However, another method is to use the data received as an offset, wherein the driver circuit can have any desired resolution and the bits received are used to modify the prior value. Certain key values can also be utilized to set the value to 0, half intensity, and so forth from which a speedier path to the desired intensity is provided. It will be appreciated that intensity changes from one cycle to the next need not occur in a single cycle, wherein this method reduces the amount of data being pushed out on the common signal with each cycle.

It should be appreciated that determining correction factors can be readily accomplished such as by configuring the USLED to output one or more preprogrammed LED output settings in response to common signals received on the common signal. All the LEDs in the panel thus generate a short pulse output, that is registered by external detectors. For instance this can be performed once each LED is programmed with an address, therein only a single LED need be activated at a given time. Alternatively, the output mode can be utilized prior to address programming, wherein each LED, groups of LEDs, and so forth are activated so that their intensity can be detected. In the simplest mode all LEDs are activated at the selected power and color, which can be held at that setting while the actual outputs are checked and correction factors determined. Once correction factors are determined then the correction values are programmed into the non-volatile memory, thereby eliminating the need for the controller to determine corrections on the fly for the incoming data.

USLED—Programming of Array Address.

Referring to FIG. 11 above, the mechanism for detecting a trigger as depicted by blue LED 28c whose characteristics change in response to detecting light input, such as when in an input mode, which is detected by a threshold comparator 32 which activates address program loading.

It should be appreciated, however, that other forms of inputs may be utilized for generating this trigger, such as by coupling other forms of sensors to a threshold sensitive device. The programming trigger can be generated in this way for loading an address which is available or for loading a correction factor.

Alternate mechanisms can be utilized for generating programming signals to each of the units receiving the parallel signal. Alternatives to the use of optical communication include a number of options a few embodiments are described below.

(1) Laser. A high intensity light source, such as a laser is directed into the package, perhaps into a facet or other accommodation for receiving the intense light. In this way the light impinges on a detector which need not be very sensitive, such as a portion of a conventional circuit. The accommodation can comprise light pipes, reflective means, lenses and the like to direct the intense light source to a detector.

(2) RF. Directing high frequency electromagnetic radiation, such as directional radio signals (i.e., GHz to THz) from an antenna to the package. The signals are preferably generated from a single antenna source which moves about over the array of elements generating a programming signal to each one that is synchronized with the signal on the parallel bus.

(3) Magnetic/inductive. The element contains a magnetic or inductive detector for detecting the presence of the programming signal, wherein the internal address may be programmed.

(4) Contact/proximity. Signal source contacts, or is held proximal to the exterior of the element, wherein it can detect the programming signal by detecting the electric field or capacitive coupling of the signal into the element. A separate contact, such as on the carrier outside of the optical lens, can be provided to which the programming signal is connected for programming the device.

USIO—Universal Synchronous Input/Output.

This relates to the USLED system allowing the technique to be utilized for collecting inputs. The inputs can be collected separately or in conjunction with outputs to the elements. The elements are programmed to an array address position, for example using any of the methods outlined for the USLED. Then upon detecting their address they generate information for receipt by a controller at a particular timing in relation to the address decoding.

In one embodiment the controller generates an address signal and then holds its output in a tri-state mode, wherein output is preferably biased slightly toward ground or Vcc. Upon detecting the address the element then powers the parallel signal line with return data for the controller. If the element is to only selectively generate an output, then the addressing signal can include a command as to whether or not to send a response and optionally select what response is to be returned from the element. Each element may be configured to pull down the voltage on the parallel address signal, or to source current from an on-board charge storage element, such as capacitor, which is discharged for communicating a signal to the controller. Less preferably, a separate signal line can be provided for communicating between the selected element (selected by the address) and the controller.

An example embodiment is depicted within FIG. 11, a block diagram of an input circuit is shown having a conditioning input device 34 coupled to a timing device 36 while the converter circuit 12 is configured for driving the parallel bus at the appropriate timing with the data bit received from the input. It should be appreciated that this technique can be utilized for driving any number of inputs. Furthermore, the inputs can be analog inputs which are converted within the device to a PWM output (i.e. signal timing indicating analog output) or converted from an analog data to a multi-bit digital output (i.e. A/D converter).

USLED in a Surface Mount Configuration.

Surface mountable USLEDs using any convenient non-through hole package, or other emissive display elements, (herein just referred to as being SMT USLEDs) are mounted on simple backplanes. Each SMT USLED comprises one or more LED elements that are connected to a (USLED) circuit for performing the decoding of the APA signal and the intensity control of the LEDs to which it is connected.

The SMT USLEDs may be configured using the preferred two wire bondout as described for use with the leaded USLEDs described in the original USLED application. The backplane for connecting the two wire SMT USLEDs may be fabricated conventionally or with any convenient and preferably inexpensive method for routing a power and ground plane to the SMT USLEDs. A ground and power plane may be easily created on any surface by an additive process wherein a base material is either inherently conductive, or upon which a conductive material is adhered or applied, wherein an insulator may be formed upon which a second conductor may be fabricated. This additive process of fabricating a “circuit board” has been effectively utilized for the fabrication of low priced consumer goods such as calculators and the like. The lack of controllable resolution for the technique not being an impediment in the present application as the traces may be quite large.

The SMT USLED may be alternatively configured with additional connection, such as described for use with the OLED USLEDs, for selecting addressing and for receiving an address line separate from the power plane and/or one or more of the additional control signals, such as the clock, column synch, row synch, reset, and so forth. Even with separate control signals it will be appreciated that the circuit trace density is still quite low when compared to that which would be required with conventionally driven SMT LEDs. The address for each SMT USLED may be programmed into the device using the optical or other techniques described. The SMT USLEDs may also be programmed prior to or during the automated place operation.

If a multileaded SMT USLED package is utilized with sufficient leads for the addressing bits, then leads may be bonded out which may be pulled to either power or ground to establish the address for each position. Addressing in this manner is easily accomplished as a pattern may be created on the backplane that is either connected or non-connected to either power or ground for pulling selected addresses of the SMT USLED chip to either power or ground while the other leads are weakly biased otherwise. For example a pattern of conductive traces from an upper layer added power plane may extend to contact selected address lines which indicate to the SMT USLED what address it is located at on the display. It will be readily appreciated that a solid layer or liquid applied layers (that subsequently harden) may be added over a set of mounted SMT USLEDs for providing connections therebetween as well, however, the irregular surface generally reduces the effectiveness of this method.

USLED—Device Array Substrate Embodiments.

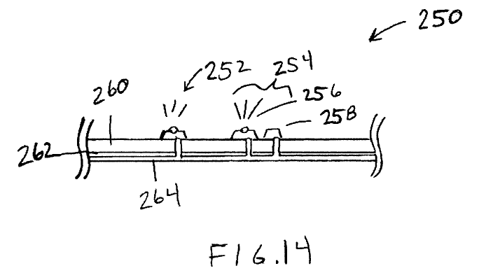

FIGS. 12 and 13 illustrate a display device array 200 having USLED control circuits integrated within the display elements. In addition, this embodiment is depicted as being capable of being programmed to an address during the fabrication process. It will be appreciated that the array can be created of any desired size without the necessity of running row and column lines throughout the material. There are a number of advantages to this approach, one being the simplicity of customizing the solution to any desired display size without the need of changing drive programming.

The embodiment shown in FIG. 12 depicts a polymeric LED array 200 having a layered polymeric substrate 202 upon which organic LEDs 204 are fabricated. The signals for driving the array are preferably embedded within the power lines 206, or with optional signal lines including lines 206′ providing USLED control.

The addresses of each output element can be programmed according to any USLED programming method described, or it may be programmed to position during fabrication, such as by depositing layers (i.e. conductors and insulators, or active address generating circuits) selectively within a region 208 that provides a fixed location address pattern.

In FIG. 13 an output element 204 is shown with address region 208. The OLED structure 210 is represented with two organic semiconductor layers 210 beneath a transparent conductive layer 212 and above USLED drive circuit layers 214 which drive the output of the OLED in response to data received in parallel at the address retained in address region 208. Alternatively, address programming may be configured in other ways without departing from the present invention.

The addressing circuits for USLED are embedded into a substrate, such as a polymeric circuit material. The address of each element can be programmed separately or the address printed into the circuit at each array location. The input and/or output element is joined or fabricated on the array, either at the time the array is printed, or at a later time as a separate element.

USLED—Heat Sinking Substrate.

In the simple case this can be implemented with the USLEDs as already described, such as surface mount LED packages that have the internal USLED circuits. The PCB/substrate to which the devices are mounted is configured as a heat sink containing the necessary power and signal connections. For example the USLEDs can be mounted to a backing that contains a first metal sheet providing a first power contact (i.e. ground) and sinks away the heat, which is joined through insulation to a second sheet providing a separate electrical contact.

A common signal can be passed over the first or second sheet to drive the LEDs or one or more additional planes may be provided for coupling the control signals in parallel to all of the USLEDs on the backing, or at least a section of the backing if it defines multiple regions being controlled separately. One form of heat sinking backing can be fabricated using a PCB fabrication process which results in a heat sinking board. For example, “Thermal Clad™ by Berquist Company in Chanhassen Minn. By using a heat sinking backing, the heat dissipated by the LED elements as well as the control electronics can be dissipated across the expanse of the backing material, therein reducing the need for dissipation structures within the USLED, while promoting more even temperatures on the USLEDs which populate the backing.

FIG. 14 illustrates an example embodiment 250 in which either USLEDs with integrated electronics 252, or less preferably LEDs having separate circuitry 254 (LED 256 with driver 258) are mounted to a heat sinking substrate 260, such as formed from a steel material of an appropriate thickness. The LED elements and drivers are thermally coupled to the face of heat sink 260 to dissipate the energy of the devices. A second conductor 264 is depicted in separation by insulator 262 from the heat sink. In this example the USLEDs are considered to derive both their power along with data and address signaling from the two conductor bus. Feedthroughs 266 from conductor 264 are shown connecting to the USLED 252, LED 256 and separate circuit 258. It should also be appreciated that additional layers can be provided such as to provide one or more separate address-data signal planes so that the data need not be extracted from the power signals.

A Few Example Display Types for Use with USLED.

Displays made using the USLEDs can include all sorts of different applications including the following, separately or in combination with one another and with conventional display apparatus.

One dimensional display arrays. The USLED can be used within light strings, branched light strings, and so forth.

Two dimensional display arrays. The USLED can be used within advertising signs (indoor and outdoor), system displays (athletic equipment, status displays, computer displays, and so forth), automotive displays and lighting (turn signals, brake lights, side indicators, etc.), stage lighting, and so forth.

Three dimensional display arrays. The USLED can be used within ornamental displays. The technique scales to any arbitrary complexity level since to row and column lines and drivers are not needed.

Synchronous Optical Programming Technique.

The synchronous optical programming (SOP) technique which in one embodiment uses the Array Position Addressing (APA) described, which more generally may be utilized for any ordered, or non-ordered, plurality of devices. For example with output elements, such as displays, and with input elements, such as optical detectors, along with combinations thereof.

If desired, data may be read from the elements connected on the power plane carrying the piggyback addressing signal.

An open time slot after each address transition can be provided in which the controller enters an input state to read transients on the backplane, and each element then after decoding its address, and optionally setting a data output, can generate a data response to the controller within the timeslot window. The response is formatted in a similar manner as data arriving at the elements from the controller.

Elements that lie on a single string. The same two axis USLED control circuit may be utilized, or a single axis control circuit configured to have only column driving. Use of APA according to the USLED method can be used to implement numerous single axis control situations. Example embodiment—Fau neon lighting with LEDs within a string that may be embedded within a plastic resin.

Use with randomly disbursed elements.

Elements which are not retained in a fixed pattern may be programmed by this method. The location is dependent on how the elements are programmed, wherein any complex pattern of lights may be supported. Example—Icicle form of Christmas lights, wherein drop strings containing lights are connected to a lighted main string. Example—items scattered on a surface, which are not regularly ordered, (wherein more than one element may respond in a given location) however the result is still useful.

Specific use with E-Paper.

An array of electric program heads may be disbursed on a sheet for programming an area of e-paper, or a linear array of elements over which the sheet is passed.

Reducing Noise of the signal riding the power plane.

It will be appreciated that an inherent aspect of the present invention is that a solid ground plane is provided to reduce RFI. This ground plane section within the backplane can be faced toward the outside of the display to block RFI through the backplane while a metallic housing, or other form of ground plane used, to house the back side of the display and thus shield RFI generation. However, the following are additional aspects that may be considered in certain applications if further noise reduction is necessary.

As select applications may be sensitive to noise generated as a result of the signals riding the power plane a few application notes are in order.

The signal may be encoded in a number of alternative ways, such as modulation schemes such as delta modulation, wherein only pattern changes are sent over the plane. To minimize RF generation the modulation scheme utilized may be selected to reduce the sub-band modulation within the signal, such as by altering coding from cycle to cycle or using a rolling encoding scheme wherein the same waveforms are not repeatedly sent for a static display. Also power fluctuations may be averaged out by properly designing the encoding so that changes to the display outputs do not create significant noise feeding back through the power circuits.

Arrays created by self-assembly methods.

The described USLED method is well suited to self-assembly processes wherein the USLEDs can be self-assembled onto a backplane (preferably a two-wire backplane). One form of self-assembly comprises floating packages over a surface wherein upon drawing off the liquid, and often subject to mechanically oscillating the surface, the packages having a shape that fits the surface in a predefined way become engaged in cutouts or detents in the surface and may then be retained using wave soldering, bonding materials, or overlays.

By way of example, in self assembling USLEDs, each USLED may be configured with a pyramidal base, (cross section being circular, square, triangular, hex, and so forth) that is heavier than the optical output side of the USLED. A pair of contacts would be provided along the height of the “pyramid” which upon assembly would make contact with the contacts within the backplane. For example a first contact may be located at the time of the pyramid and a second contact located at the base of the pyramid. After self-assembly securement and electrical contact for the USLED may be provided by soldering the two sides of the USLED to the backplane, (automated positional soldering, or wave soldering of the surfaces [although capillary action could result in bridging]), or using a conductive adhesive applied to each USLED on either side to secure and connect the USLED to the backplane.

It should be appreciated that although described in a simple configuration with but two planes, power and ground, over which the display signals are superimposed, the present invention may support any number of planes of the display by separating functions within the present invention to reside on a separate plane. For example, controlling each color on a separate plane, or controlling the programming voltages on a separate plane, and so forth.

Panel Display Incorporating USLED Techniques.

To reduce the addressing complexity within an emissive display, wherein the panel may be controlled from a single serial signal of sufficient bandwidth. Circuit layers are assembled on a substrate for the universal synchronous LED, or less preferably the Universal Sequential LED circuit, also described by the author. The substrate may comprise a conventional substrate material, such as glass substrates, and flexible substrate materials such as polymeric materials. The circuit, as described in the USLED application may be configured to drive one or more elements, typically associated with a single pixel. It will be appreciated that simple digital circuitry such as required for manufacturing the USLED circuits may be fabricated on the polymers. The circuits may also be deposited onto a substrate such as using self assembly, autoplacing, or other convenient fabrication techniques.

It is preferable that aside from the power and ground supplied to each circuit, that at least one additional digital address line, and optionally signals for clocking, reset, row synch, and column synch, be added so that the circuit elements need not contain the needed circuitry for extracting these signals from the power bus, or other essentially muxed control lines. Although this may appear to complicate the simple circuits of USLED, it is readily achieved and reduces the myriad number of row and column lines that would otherwise need to be driven in a conventional flat panel.

The area of a large display panel may optionally divided into sections that utilize one or more separate addressing signals, if the refresh rate of a monolithic display would otherwise prove insufficient.

Rather than requiring the address for each cell to be optically programmed, as previously described, the cells may be programmed to fixed locations by any convenient method, such as by using a metal mask layer which configures address lines from the address comparator circuits to either high or low. By way of example the addresses may be set by using a mask step for setting addresses for each cell of the control circuit, for example, by connecting selected address lines to power which have been otherwise biased toward ground. It should be appreciated that this application is unlike that of discrete LEDs wherein it is unknown where they will be attached to the power and ground plane.

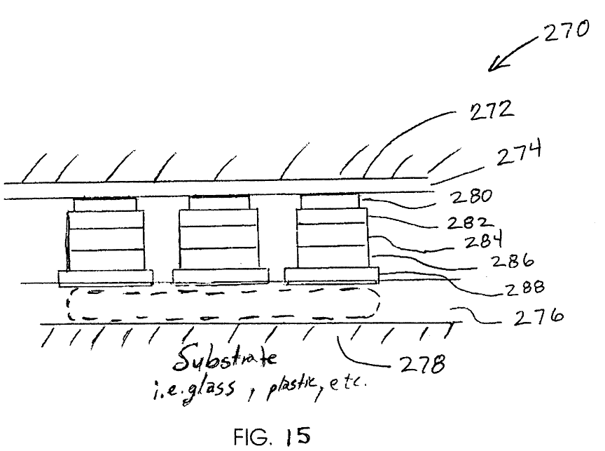

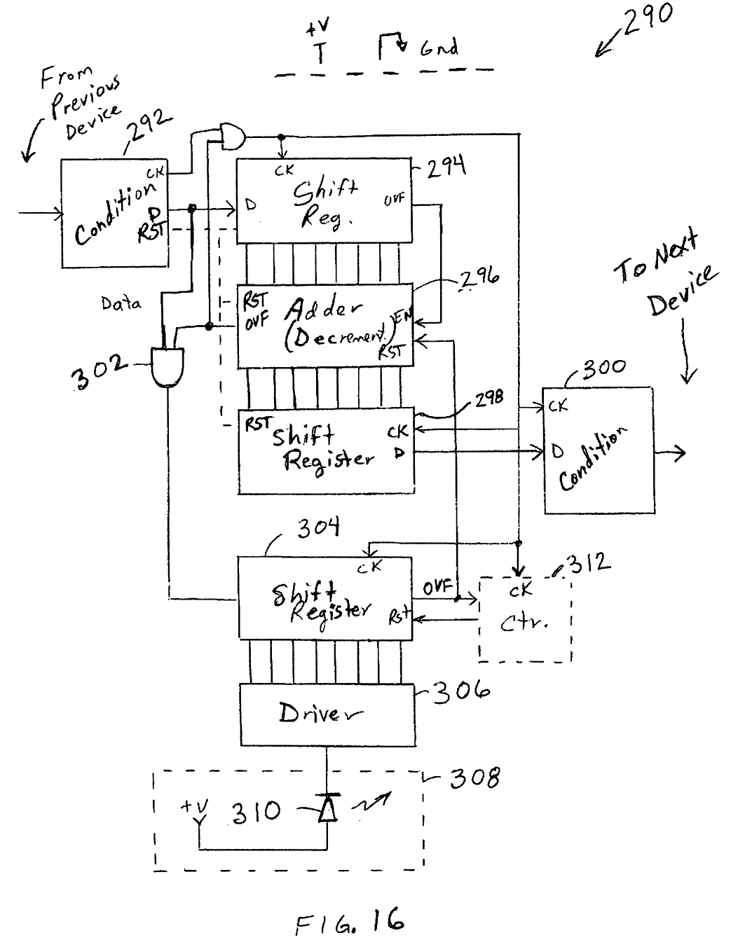

FIG. 15 exemplifies an OLED structure 270 built with transparent cover 272 (i.e., glass) and between a substantially transparent ground plane layer 274, and a set of circuit layers 276 fabricated over a substrate 278. The circuit layers may be fabricated using a step and repeat process, or other form of fabrication to create a large area circuit. Layers 280-288 are shown for each pixel (only three shown, no limit on allowable number). The address settings at each position may be embedded into a single mask or in using an iterative method with a metalization mask portions of which are modulated for the addresses for sequential portions of the display. It will be appreciated that a number of alternative methods may be utilized for constructing OLEDs that are controlled using techniques taught for USLED display control, without departing from the present invention.

The USLED control logic is embedded within the circuit layers on the substrate upon which the OLEDs are constructed thereby minimizing the need to route addressing lines, and for multiplexing the pixels of the display.

Universal Sequential LED (or Other Output Elements).

To drive output elements that are individually addressed without the need to program each node or to provide address lines to each node. This invention is an off-shoot of the Universal Synchronous LED but has a different structure and is directed at different application areas.

This display driver mechanism is similar to that of that of the USLED which references a programmed address value, such as in FLASH, to determine its address. Within the present invention however the elements are connected serially to one another and the address of a particular unit is determined by its position in the chain. The invention allows a single or multiple axis array of elements to be interconnected and addressed without the need of programming the address within each element. The present method is particularly well suited for use within arrays in which the elements are subject to low bandwidth changes or status updates.

A number of embodiments exist for applying the invention, the following are provided by way of example.

One of N Element Selector (ONES): Allows for the selection of a single element, LED, mirror, etc. within a given group or subgroup of elements.

(1) Embodiment—Single row—Each element contains a counter chip and it derives a clock from the counter input. A counter value corresponding with the series position of the element to be activated, i.e. 100th element, is transmitted to the first of the series of elements. The first element counts down the value and since it is not yet zero, passes it to the next element, and so forth, until the value has reached a predetermined value (i.e. 0, or overflow) wherein that element then is activated directly (goes to active ON), or it picks up data from the signal such as setting information (i.e. intensity), timing information (i.e. ON time) or combinations thereof. The driven element may be optionally configured to turn off automatically after a fixed number of cycles, a number of cycles as read in the data, or be turned off upon receiving data set to an OFF level, or turned OFF when another element is selected.

The counter values sent out may be phase changes in a square wave signal, wherefrom a single line ties all elements and clocking is easily derived from the signals.

If state change synchronization is required, wherein the change of one element to ON must occur synchronous to another element being turned off, then a SET signal embedded within the clocking can be used to commence a new setting for a device just receiving data, while terminating the setting for an element that was previously active.

If synch is not critical then elements passing the data through can automatically be deactivated, however, a variable overlap of activation will occur as a result of position on the system.

FIG. 16 depicts a block diagram 290 of an embodiment of the display control method and system, with the circuit for a single element shown. It should be appreciated that the circuit is generally simplified to show the functions performed within the device and is not meant to be an actual schematic. Furthermore, a number of alternative embodiments will be readily apparent to one of ordinary skill in the art without departing from the present invention.

The circuit is preferably incorporated with an element to be controlled such as a display element, a MEMs device, or a device to be read. A single signal is shown being received within the device, this signal may include a clocking signal a serial address and a set of data. It will be appreciated that the multiple signal may be alternatively utilized although this increase the pin count. Furthermore, additional signals such as framing, reset (shown in a dashed line), and so forth may be incorporated without departing from the invention. A reset line may also be generated in response to the absence of data bits for certain length of time, wherein this assures that all circuits are reset to an initial condition, except for the previous display output setting. In addition the address bits may comprise multiaxis array addresses while any number and organization of data bits may be supported.

A signal containing clock and data are received by a conditioning circuit 292 which separates the clock from the data with the data being passed to a shift register 294. The diagram shows a circuit wherein a one bit is presumed to precede the address bits to be used for synchronizing the elements and a one bit is again added to precede the outgoing bits. Once the address is loaded in the shift register, which for example may be detected by the overflow of the start bit, the parallel output from the shift register is decremented within an adder 296 (although it could be incremented instead using a complementary address value). If the address does not meet the selection criterion, which in this case require the address to have reached an underflow value, the result of the decrement is loaded into a shift register 298 for output through an output conditioning unit which combines the data and clock for output to the next device.

If however the address has underflowed, indicating that this element is being selected for output (or alternatively input) then the overflow signal gates on 302 the shifting of a set of data bits that comprise the desired output from the conditioning circuit 292 to an output control shift register 304 whose output is provided to a driver circuit 306 for controlling an element 308, exemplified as an LED style element. An optional counter circuit 312 is shown that may be used to deactivate the display output after a given number of clocks, so that the element need not be addressed again for turning off the element.

It should be appreciated that the parallel decrementing of the address may be replaced with a serial form of addition/subtraction, such as may be facilitating using a gray scale coding or similar to reduce the necessary bit conversions.

(2) Embodiment—Additional element axis—Additional element axis may added. For example a two dimensional array of one of N selection. The count value contains a value for each axis—such as two counters for a two-axis array of elements.

A number of horizontal rows of elements are connected to a vertical row of null-column elements which will only decrement the row number and pass the data along. The null-column element may pass the counter value only if it reached the predetermined row count setting (selects the appropriate row) or it may pass them all along wherein only the individual elements within the correct row can reach a correct value for both the column and row.

(3) Embodiment—Few of N Element Selector (FENES)

If overlapping of activation is allowed, or maybe a small number of active elements are supposed to be active, then the scheme may be slightly altered to cover this application.

(a) Allow elements to stay on for a programmed period of time. Wherein the data following the properly decremented (or incremented) count indicates the time that the element is to stay active, optionally in addition to setting information (i.e. intensity).

(b) Require elements to be deactivated afterward by explicit setting. Preferably include a particular RESET count value that is propagated unchanged so that all elements may be set to a particular condition (ON, OFF, or other predetermined setting).

Selection of mirrors using the technique.

The correct mirror may be selected using a timing structure as found in the USLED application. Address for each consecutive mirror may be selected by surface etching away address selection bits of each mirror, or applying a conductive material (thick film or similar) to create address bits, so that a common circuit for driving the mirror may be utilized. (no optical programming is necessary).

Count down addressing—requires power and ground ALONG WITH an input and output line for each cell (1-N). A count value x is input for cell 1 which decrements the count to x=x−C (wherein C is a positive or negative constant). If the count has reached a predetermined value, such as zero, then the given cell is selected and retrieves the data following the count value. Otherwise the modified count and unchanged data passes out to the following cell. This approach allows for the creation of single and multiple axis array addressing without the need of addressing each cell, the address is inherent within the relationship between the cells. In a two dimensional array (Row and Column), two count values are provided along with one or more associated data values. An initial Column is set as an intersection of a set of rows and does not contain an associated element. It modifies the Row count, and passes along the associated column count ONLY to the correct row.

It will be appreciated that the controller may update the data immediately after a prior piece of data, it need not wait for synchronization and so forth.

The method is suited for use in systems wherein a 1-of-N selection arrangement is required, such as in arrays of mirror assemblies wherein only one element is to be selected for directing an optical beam.

Details and Extensions on Method of Array Position Address Programming

The method of array position address programming within the present invention provides a method of communicating relative position information to elements within an array for registering an address wherein they can respond based on location within said array, while not requiring a cross-point grid, or sequential element-to-element counter operation to take place.

The present aspect of the invention is applicable to USLED displays and similar devices which incorporate what is being referred to herein as Array Position Addressing (APA) that allows the elements to be controllably addressed, such as from common bit streams, without the need of individual row and column lines, or sequential information being decremented or serially passed along a string of elements.

It should be appreciated that the programming method is applicable not only to LED display but may comprise any form of display element as well as other output elements, such as movable mirrors within a MEMs element, valves, and so forth. Furthermore, the circuit elements within the array may less preferably comprise input elements or elements with a combination of input and output functions. By way of example the devices may comprise sensors, such as image, audio, pressure, temperature, magnetic, and so forth, wherein their electronic address is set in relation to their physical position, such that their response back to a controller is associated with the address on the backplane, or common signal bus, wherein the data may be correlated with position without the need of mapping identifiers on individual elements to physical addresses.

One aspect of APA on USLEDs which was described is that of providing in-situ optical programming wherein the USLEDs are programmed from an optical source array (generally a matching, or a superset, of the target USLED array) which programs a position address into each USLED on the target array. After programming, each display element retains, such as in FLASH memory, the address within the array that it is to be responsive to.

The present section expands on the in-situ optical programming previously described. It will be appreciated that the optical programming technique provides an unambiguous trigger for setting the addressing within a non-volatile memory to an address as found on the power plane, or a separate signal(s). This trigger condition may be provided in a number of alternative ways as described herein.

(1) Laser scan—the light source may comprise a laser light source configured to scan across optically sensitive elements in a pattern that is synchronized with the addressing that is being generated over the bus. The laser source may be scanned by using a mechanical translation stage wherein it physically moves over the area to be programmed, or a light directing means, such as a moving mirror which deflects the light toward the subject display element.

It will be appreciated that a mechanical translation stage retained sufficiently proximal to the set of light sensitive elements may be utilized instead of a laser source for triggering the address loading within the elements.

(2) Light Masking—the light to a particular light sensitive APA element may be selectively provided by way of a mask that allows the light to reach only one element. Alternatively, masking may be performed with converse logic to mask light from reaching all but the masked off element. The mask may be moved on a translation table, or other means of masking off one, or all but the selected element(s).

(3) Field intensity scan—The magnetic or electrical field intensity is raised to select a given element. Preferably the element is first placed into a programming mode, such as by altering the voltage to the device (i.e. raising it to a programming voltage), having the element remain in a program mode until programmed to an address in a given range, and so forth. The field intensity may be registered within the element according to a number of known techniques, such as the use of an inductive loop. The unit has a field threshold that upon being crossed when in program mode causes it to load an address register with the address count which has so far been registered. It will be noted that field intensity varies with square of distance wherein selectivity is easily achieved.

The programming may be performed with any convenient device producing a sufficiently selective pattern of field intensity such that other elements are not inadvertently triggered. By way of example, a stylus or wand device providing proximity signaling for setting single elements of areas of pixels, and so forth.

One preferred method of programming is by creating a conductive row and column grid for positioning proximal to the unit wherein the voltages between active row and column set up a sufficient field intensity for exceeding the programming threshold. To increase the available field strength the grid may be configured with conductive extensions which can increase the proximity of the conductors to the element itself. These conductors may extend on either side of the element, over the top of the element, or otherwise be retained proximal so that sufficient field strength is achieved.

For a very simple programming device, for example considering a display that is assembled by a user in a desired configuration, a simple one magnet may be configured for being easily drawn over an array of elements in synchronous with the addressing being sent. For example, a counter could display the element number and the user then touches the magnet to, or near, the element and then moves on to select the following element and so forth.

“Noise” (proximity) programming—in a similar manner the noise being coupled to the element could be utilized for triggering programming. This is an AC version of the field strength triggering above, wherein the triggering is responsive to a given threshold of AC. Furthermore, the threshold can be conditioned to a particular pattern being received as a field strength. Anyone experimenting with electronics will have noted that that a finger touching near the input of an op-amp couples the 60 Hz lighting noise, along with any other spurious signals, into the input. This coupling may be utilized in noise programming. A noise signal which may contain a predetermined signal is passed nearby or in contact with the element, which senses the “noise” exceeding a given threshold and programs the attached element accordingly. Preferably, the program mode is only activated in response to a high programming voltage and/or signals received that pull the device into a program mode. No connection need be made to the device.

Capacitive programming—in a similar manner proximity of a material near the element may be utilized to sufficiently change the capacitance of a capacitor within the element to exceed the programming threshold. For example, a portion of the exterior of the housing forms a capacitor that couples a signal into the device for programming. A material may be brought into proximity, or contact with the element to be programmed which is synchronized with the APA addressing.

Sensor address programming—Each element can be similarly made to respond to a condition for triggering programming. For example the sensitivity may be linked to the particular condition that the sensor is configured to sense. By way of example and not of limitation, the threshold may be established by pressure changes, such as applied to a pressure sensor that is in programming mode. By way of further example, the sensor may be a temperature sensor, or similar element, wherein a temperature change can be used to trigger programming. Less preferably, any form of sensing element may be utilized that can be individually addressed according to the characteristic being sensed.

It will be appreciated, therefore, that the in-situ programming of the address within the element may be made responsive to a number of conditions that trigger loading of the address from a signal source, bus, backplane, or similar without departing from the teachings of the present invention.

Detailed Flowchart of in-situ Programming.

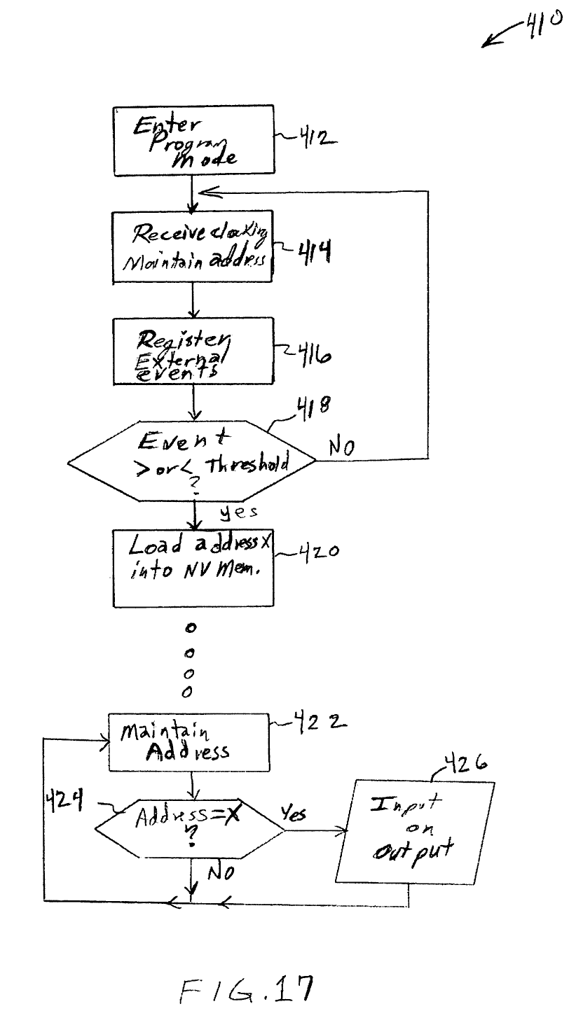

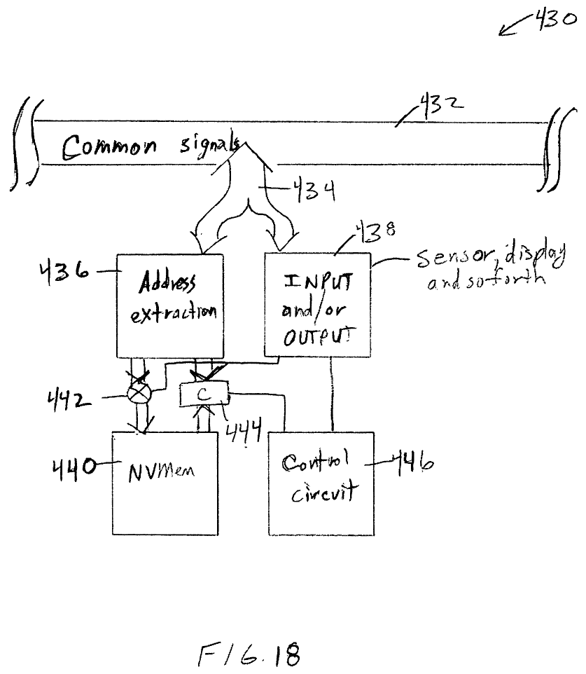

FIG. 17 is a flowchart of the method 410 according to the present invention, showing blocks 412 through 420 illustrating an address programming sequence and blocks 422 through 426 depicting an operating sequence.

Programming mode is entered at block 412, such as by receiving a predetermined signal, a predetermined operating voltage, or an alternative condition signifying that the element should be prepared to program an address. The element receives clocking from the common set of signals and maintains an address according to block 414. Upon registering a predetermined event (or one of many) as per block 418 a comparison is made to determine if this event meets the conditions for address loading. If so, then the address is loaded into the non-volatile memory at block 420 wherein during operation the element can discern to which address it is to respond based on the physical position to which it was programmed.

During operation the element maintains an address at block 422, such as a counter upcounting an address value. The address of the count is compared with the address loaded in the non-volatile memory at block 424 during programming. If a match is found then the element responds to the address by inputting or outputting data from the common set of signal as per block 426. It will be appreciated that outputting data from the set of common signals may comprise outputting an intensity or color to a display element, tilting a mirror a given amount, or other forms of output. Inputs may comprise sending collected data from a sensor over the common signals, or communication of other data over the common signals.

FIG. 18 depicts a block diagram 430 of a circuit element configured for responding to an address according with programming that is set based on the physical position of the element. A set of common signals 432 are interconnected 434 between an array of the circuit elements, this may an array of from one to any number of desired dimensions. An address extraction circuit 436 operates to determine the address on the common signals in response to clocking signals detected therein. For example, the clocking may be utilized for incrementing one or more count values corresponding to an address. An input and/or output section 438 operates to sense trigger conditions of one or more inputs for controlling programming and it may be utilized for communicating data over the common signals which has been gathered from the input. I/O section 438 may also include output portions, such as display elements, mechanical positioners, valves, optical transmissive controllers, and so forth, in response to addressing. A section of non-volatile memory 440 allows the circuit element to be programmed to an address corresponding to the position of the element within the array. An address being loaded from address extraction circuit 36 to the non-volatile memory in response to an input within I/O section 438 reaching a sufficient level to activate a switch 442 allowing the address being maintained to be loaded within the memory 440. During operation of the unit, the address being maintained by address extraction circuit 436 is compared with the programmed address within the non-volatile memory 440 within comparator 444. Upon a match occurring a control circuit 446 is activated wherein it controls the I/O circuit for collecting data from the set of signals for output to a display or other output element, or the communication of data from the input device, such as from a sensor, over the set of common signals 432.

It should be appreciated that the set of common signals may comprise power and ground, or it may comprise a multiplicity of signals routed commonly to an array of elements. It will be appreciated that a number of arrays of elements may be interconnected with different sets of signals interconnecting them without departing from the teachings of the present invention.

Addressing within Pick and Place Equipment.

Establishing APA style location addressing for elements in an array may be alternatively performed at the time each individual element, such as display element, is bonded into the array. It will be appreciated that conventional programming equipment programs each element with the same program code. While serialized devices are programmed with different serial numbers, but there is no need for matching the serial number with a location.

An aspect of the present invention includes a pick and place system, or similar means (referred to generically as a pick-and-place system or simply PnP system) of loading a printed circuit board, or other electronic parts substrate or carrier device, (referred to herein generically as a printed circuit board or simply PCB) with electronic elements to form an array (1D, 2D, 3D, regular, sparse, or irregular).

The PnP system is adapted with a programming head configured for receiving an unprogrammed electronic element, such as an LED display element, having a known relationship to the location on said PCB at which the element is to be electrically connected (inserted, attached, bonded, joined, and so forth and combinations thereof).

The programming to be loaded to the element is then updated in response to the location in the array that the electronic element is to be connected. After programming, it is preferable (though in some cases cost prohibitive) to test the electronic element at the programmed address to assure it is correctly programmed. If correct, then the electronic element is allowed to pass through for being placed and connected to the PCB. If the unit does not function at the correct address, then it is rejected and another unit is loaded into the programming head and programmed to the same location address. The programming head may connect to the device and apply programming in any desired manner. Electrical connection is established with the element under programming (EUP), while additional non-connection inputs may also be utilized, such as light detection and so forth, to provide additional information or trigger information to the element. For example a multileaded element may be programmed solely through its leads, by entering a programming mode and loading data into the part. A device with fewer leads, such as certain USLED devices, may have only power and ground pins, wherein a trigger signal can be received by flashing a light upon the LED element. The LED operates in a sense mode in this scenario, when the device is powered to the programming voltage (or otherwise set in programming mode), wherein an address counted by the EUP from signals piggybacked on the power bus, is loaded into non-volatile memory in response to the light trigger. Other elements can be similarly programmed in response to other forms of sense input, such as pressure, RF energy, acoustics, and so forth. It will be appreciated that a number of alternative programming mechanisms exist for various types of EUP devices, whether programmed solely through electrical connection or augmented with sense inputs, such as for triggering.

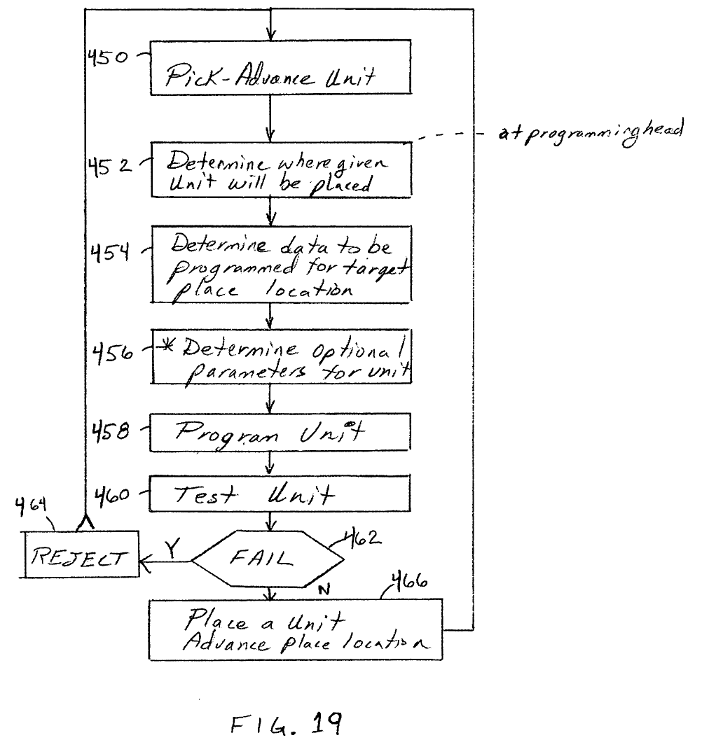

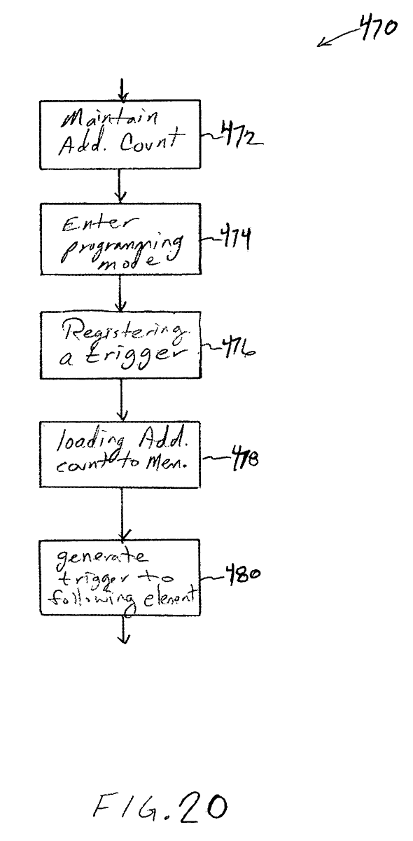

FIG. 19 is a flowchart of a method of setting location addressing within a pick-and-place system according to an aspect of the present invention. Block 450 represents a pick advance step wherein the electronic unit (which is to be placed for connection on a PCB) is advanced along the queue. Typically advancement occurs as the result of a pick (from reel, bulk, or other repository of elements) after the head of the unit queue has been placed into, or onto, the PCB (or similar).

It should be appreciated that the pick and place equipment may have a queue size of only one, wherein a unit is picked, programmed, and then placed into, or onto, the PCB without being moved through queue intermediate the pick and programming step or the programming and place step. In either case the pick or advance of the queue represented by block 450 brings a new unit into the programming head.

A determination is made as per block 452 as to where the given unit loaded in the programming head will be eventually placed on the PCB. This determination can be table driven or calculated in response to the location of the element in the queue toward placement, the location for the next placement and the placement route being followed. A simple equation for this is given by L_{pcb}=(Lₚ+L_{q})_{placemap}. The location L_{pcb} is the location (target) where the unit is to be placed on the PCB when it emerges from the queue (if a queue exists). The location Lₚ is the current placement location on the PCB or similar, and the location L_{q} is the position in the queue of the unit as registered as a number of units from reaching the placement head. The ( )_{placemap} is the modulo for the placement map, it will be appreciated that a unit in the queue may be placed on a subsequent PCB if its location is beyond the current PCB upon which units are being placed.

Data, preferably comprising a location address such as an APA address, is then determined as represented by block 454 in response to the position to which the specific unit being programmed is to be placed. Optionally at block 456 additional parameters for the unit may be determined, for example selected units within an array may be specially programmed with features suited to their position on the PCB (i.e. providing line terminations, altered output response, or other operational change dependent on position to be placed).

The unit at the programming head is then programmed with the data, along with optional data if necessary as per step 458. The programmed unit is then optionally tested as per block 460, preferably the test includes checking if the data has been properly programmed into the unit. By way of example in a USLED device addressing can be generated on the power lines and the output of the LED checked to assure that it generates correct light output response to the location address programmed into the device. The method of testing a device depends on the characteristics of each device and device testing is well known to those of ordinary skill in the art. Unit failures as detected at block 462 are rejected as per block 464, wherein the unit is dropped from the queue and another unit picked to replace it. On rejected units a placement has not occurred wherein the place location Lₚ does not increment. Typically these units are binned in one or more failure bins, while the software executing the programming and placement of the system tracks the failures and modes thereof.

If the programmed unit passes the test then it continues in the queue toward the place location as represented by block 466 and is advanced in the queue for each unit placed.

As modern placement equipment can operate at high rates of speed, it should be appreciated that a number of queues may be established leading to multiple programming heads, wherein the place head sequentially retrieves a unit from each queue. In this situation programming is performed based upon location information that takes into account the number and status of each of the queues.

Method of Address Programming using Peer Location.

Programming of physical position of elements within an array of circuit elements based on proximity to one or more neighboring elements. An array of peer programmable circuit elements (PPCEs) are connected to a set of common signals, which may comprise a ground and power line over which both power and data are conveyed, or may include additional common lines.

Each PPCE element is adapted with memory locations, preferably non-volatile, within which an address for the circuit element within the array may be retained. The address in NVMem is loaded during a programming operation, which preferably occurs during a peer-to-peer programming operation.

During conventional operation, (non-programming mode) the PPCE is responsive to the address loaded in the NVMem and it will input data from the common set of signals into the circuit element for controlling some aspect of the element, such as a display output, mechanical adjustment, and so forth; and/or collect information, such as from one or more sensors, optical elements, transducers, and so forth.

The present invention provides for programming of the address based on a nearby PPCE which is already programmed. In this way programming (pre or in-situ) a single PPCE thereby provides a seed from which the remainder of the elements in the array can be automatically programmed based on position.

The method may be utilized in arrays of one, two, or three dimensions and any pattern of array may be supported, such as linear, row and column, hex, 3-D matrix, and so forth.

Each PPCE is configured for communicating a directed trigger to a nearby PPCE. The trigger is preferably qualified if any opportunity for false triggering exists, such as in relation to ambient conditions, such as light in a light triggered PPCE. Qualification may for example take the form of an ID or other pattern within the trigger that further distinguishes it from non-trigger events. The trigger may be communicated optically (UV, visible, IR, etc.), with other forms of electromagnetic radiation (RF, inductive), magnetically, mechanically, chemically, vibrationally, acoustically, thermally, or by other means of communicating a trigger condition from one PPCE to another PPCE.

By way of example and not limitation, the following discussion will be directed at PPCEs configured for use in a two dimensional array arranged as horizontal rows and vertical columns as it is the easiest to visualize; however, it should be appreciated that the technique is available for use with any array arrangement.

In this embodiment each PPCE is adjacent to four neighbors designated N-Top, N-Right, N-Bottom, and N-Left. In order to facilitate programming of the entire two dimensional array from a single seed, each PPCE is preferably adapted to communicate along both a row and a column.

By way of example, and not of limitation, the trigger signal is communicated down for a row change and right for a column change, whereas the trigger is received from the left along the next column within a row and from above within the first element in a new row.

In this embodiment, a PPCE preferably generates a column signal only if it is the first element in the row, and the 2-D array is seeded from the upper left corner. As addressing commences within a programming mode, the seed generates both a column and row trigger. The next row trigger may be generated at the start of the row wherein the next row is triggered into loading its address when that count reaches the next row address, or it may generate the next row trigger at the end of its row. The generation of column triggers operate similarly, wherein the trigger may be generated toward a subsequent PPCE in the row when the given PPCE has decoded its own address, therein relying the following PPCE to recognize that the next sequential column is the column it is to be programmed to; or the column trigger may be generated at the end of the selected address wherein the trigger can substantially coincide with the following interval wherein the following PPCE in the row need only load in the address at the subsequent timing transition for the column. It will be recognized that the next row address need not be separately communicated to following elements within a row because the trigger indicates that their position is within the current row of the address, wherein they will program their counted address into their NVMem upon receipt of the next set of clocking.

The trigger, as mentioned, may comprise any of a number of physical qualities, such as light, electric fields, magnetic fields, motion, vibration, chemical communication, and so forth. For example, consider an array of PPCE with each PPCE having a pair of electrodes near the periphery of the circuit facing downwardly to the next row, and a pair of electrodes near the periphery facing to the right. Similarly, a means for sensing the electric field (i.e. antenna coupled to sensitive amplifier) may be provided at the left and top direction near the periphery of the device. It can be appreciated that by applying a sufficient voltage across the electrodes an electric field may be setup that can be registered by an adjacent PPCE. Furthermore, the signals generated may be required to follow a predetermined sequence to eliminate false triggering. These triggers are preferably only generated when the device enters a programming mode, such as entered by doubling the normal operating voltage, or in other ways.

FIG. 20 depicts the method 470 of peer programming for position within an array. The address count is maintained in block 472 wherein the PPCE maintains the address count, such as in response to clocking detected within the common signals. The PPCE is entered into programming mode (it may have been set for programming mode prior to the maintenance of the address, such as if the operating voltage is changed) as per block 474. A trigger is registered as represented by block 476 from a nearby PPCE, preferably an adjacent PPCE in a particular direction. The trigger then causes the PPCE to load the maintained address into memory, as represented by block 478. The address may be loaded immediately or at a predetermined temporal offset from the trigger, such as upon a subsequent clock edge on one or more signals within the common set of signals. The PPCE which has just been programmed generates a trigger at block 480 to a subsequent PPCE causing it to be programmed.

Using a separate redirector.

Each PPCE need only communicate along a single path within a single dimensional array, OR if a redirector is utilized when programming the array wherein the redirector orients the addressing to the next location. By way of example, with optical PPCE having an LED output, the output from each PPCE may be coupled to the next column of PPCE down to the end of the row wherein the light is then coupled downwardly to the next lower row (or alternatively upper row) wherefrom the redirection is performed in the opposing direction and so forth so that addressing snakes its way over the surface of the array.

It will be appreciated that the technique can be modified by one of ordinary skill in the art without departing from the teachings herein.

### CONCLUSION

### Interpretation of Specification

Accordingly, it will be seen that this invention provides a system and method for controlling an array of display elements, such as LEDs, without the necessity of multiplexing, nor the need of a backplane containing row and column traces along with various distributed driver circuits. The method involves the use of address encoding within the display elements which may be performed within the target circuit. Each display element extracts addressing information from the power bus over which data is superimposed. One of ordinary skill in the art will recognize that the method taught within the present invention can be practiced in a variety of implementations which similarly provide for addressing and controlling of the display elements. It will further be appreciated that the synchronous optical programming (SOP) method of the present invention may be utilized within a variety of devices for establishing an address for the device within a single or multiple axis array. For example the SOP technique may be utilized according to the present invention with any form of output elements, or even with input elements, such as optical detectors, or with combinations thereof.

The aspects, modes, embodiments, variations, and features described are considered beneficial to the embodiments described or select applications or uses; but are illustrative of the invention wherein they may be left off or substituted for without departing from the scope of the invention. Preferred elements of the invention may be referred to whose inclusion is generally optional, limited to specific applications or embodiment, or with respect to desired uses, results, cost factors and so forth which would be known to one practicing said invention or variations thereof. For example, one of ordinary skill may find other suitable substitutes for certain applications.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A method of controlling a display element, comprising the steps of:
programming a memory within a display element to a first address corresponding to the position of the display element within an array of other display elements;
detecting a match between said first address and a second address contained within a data signal that is received in parallel by display elements within the array;
loading a predetermined number of bits of display data from the data signal in response to said match; and
outputting said number of bits to a optical element driver which controls the intensity and/or color of at least one optical element within the display element in response to said bits.

2. A method as recited in claim 1, wherein said data signal is extracted from a two lead power bus coupled to the display element on which the data signal has been superimposed for receipt by the display element.

3. A method as recited in claim 1, wherein the at least one optical element comprises one light emitting diode (LED) of a desired color, or multiple LEDs of at least one color.

4. A method of driving display elements, comprising:
generating a display signal containing a series of display settings in a pattern from which a display element address may be determined;
transmitting said signal to an array of synchronous display element;
receiving said signal within a synchronous display element;
detecting an address match for the display element within the signal;
extracting the display setting from the signal for the display element; and
outputting a display setting in response to the extracted display setting.

5. A method of programming an array address within an element of an array, comprising:
configuring display elements with an optical detector;
configuring display elements with a non-volatile section of memory for retaining an address;
optically coupling a programming array to the array of display elements;
engaging the address programming for the displaying elements; and
loading the address embedded within the signal in response to the detection of sufficient light input.

6-82. (canceled)
